(19) United States
(12) Patent Application Publication
(10) Pub. No.: US 2025/0393028 A1
(43) Pub. Date: Dec. 25, 2025

(54) INDICATION AND CONFIGURATION FOR CLUSTERED PAGING

(71) Applicant: QUALCOMM Incorporated, San Diego, CA (US)

(72) Inventor: Ahmed Attia ABOTABL, San Diego, CA (US)

(21) Appl. No.: 18/751,771

(22) Filed: Jun. 24, 2024

(51) Int. Cl. H04W 68/02; H04W 76/28

(52) U.S. Cl. CPC H04W 68/02; H04W 76/28

(57) ABSTRACT

Various aspects of the present disclosure generally relate to wireless communication. In some aspects, a user equipment (UE) may receive a set of parameters for a first paging configuration, wherein the set of parameters indicate a discontinuous reception cycle, and wherein the set of parameters are associated with a set of paging frames having a first distribution in the discontinuous reception cycle. The UE may monitor for a paging message during a paging frame of a clustered set of paging frames according to a second paging configuration, wherein the second paging configuration is derived from the first paging configuration, and wherein the clustered set of paging frames have a second distribution, in the discontinuous reception cycle, different from the first distribution. Numerous other aspects are described.

### FIELD OF THE DISCLOSURE

Aspects of the present disclosure generally relate to wireless communication and specifically relate to techniques, apparatuses, and methods for indication and configuration for clustered paging.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, an apparatus configured for wireless communication at a UE includes one or more memories comprising processor-executable instructions; and one or more processors configured to execute the processor-executable instructions and cause the apparatus to: receive a set of parameters for a first paging configuration, wherein the set of parameters indicate a DRX cycle, and wherein the set of parameters are associated with a set of paging frames having a first distribution in the DRX cycle; and monitor for a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution.

In some aspects, an apparatus configured for wireless communication at a network node includes one or more memories comprising processor-executable instructions; and one or more processors configured to execute the processor-executable instructions and cause the apparatus to: transmit, to a UE, a set of parameters for a first paging configuration, wherein the set of parameters indicate a DRX cycle, and wherein the set of parameters are associated with a set of paging frames having a first distribution in the DRX cycle; and transmit a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution.

In some aspects, a method of wireless communication performed by a user equipment (UE) includes receiving a set of parameters for a first paging configuration, wherein the set of parameters indicate a discontinuous reception (DRX) cycle, and wherein the set of parameters are associated with a set of paging frames having a first distribution in the DRX cycle; and monitoring for a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution.

In some aspects, a method of wireless communication performed by a network node includes transmitting, to a UE, a set of parameters for a first paging configuration, wherein the set of parameters indicate a DRX cycle, and wherein the set of parameters are associated with a set of paging frames having a first distribution in the DRX cycle; and transmitting a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution.

In some aspects, a non-transitory computer-readable medium storing a set of instructions for wireless communication includes one or more instructions that, when executed by one or more processors of a UE, cause the UE to: receive a set of parameters for a first paging configuration, wherein the set of parameters indicate a DRX cycle, and wherein the set of parameters are associated with a set of paging frames having a first distribution in the DRX cycle; and monitor for a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution.

In some aspects, a non-transitory computer-readable medium storing a set of instructions for wireless communication includes one or more instructions that, when executed by one or more processors of a network node, cause the network node to: transmit, to a UE, a set of parameters for a first paging configuration, wherein the set of parameters indicate a DRX cycle, and wherein the set of parameters are associated with a set of paging frames having a first distribution in the DRX cycle; and transmit a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution.

In some aspects, an apparatus for wireless communication includes means for receiving a set of parameters for a first paging configuration, wherein the set of parameters indicate a DRX cycle, and wherein the set of parameters are associated with a set of paging frames having a first distribution in the DRX cycle; and means for monitoring for a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution.

In some aspects, an apparatus for wireless communication includes means for transmitting, to a UE, a set of parameters for a first paging configuration, wherein the set of parameters indicate a DRX cycle, and wherein the set of parameters are associated with a set of paging frames having a first distribution in the DRX cycle; and means for transmitting a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a discontinuous reception (DRX) configuration, in accordance with the present disclosure.

FIG. 5 is a diagram illustrating an example of a first paging configuration and an example of a second paging configuration, in accordance with the present disclosure.

FIG. 6 is a diagram of an example associated with configuring and/or indicating a clustered paging configuration, in accordance with the present disclosure.

FIG. 7 is a diagram illustrating an example of indication and configuration of a clustered paging configuration, in accordance with the present disclosure.

FIG. 8 is a diagram illustrating an example of indication and configuration of a clustered paging configuration, in accordance with the present disclosure.

FIG. 9 is a flowchart of an example method of wireless communication.

FIG. 10 is a flowchart of an example method of wireless communication.

FIG. 11 is a diagram of an example apparatus for wireless communication, in accordance with the present disclosure.

FIG. 12 is a diagram of an example apparatus for wireless communication, in accordance with the present disclosure.

FIG. 13 is a diagram illustrating an example of an implementation of code and circuitry for a communications device, in accordance with the present disclosure.

FIG. 14 is a diagram illustrating an example of an implementation of code and circuitry for a communications device, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Some wireless communications systems may include a user equipment (UE) communicatively connected with at least one network node, where the UE and/or the network node may support various communication modes. The UE may support a connected communication mode (e.g., a radio resource control (RRC) active mode), an idle communication mode (e.g., an RRC idle mode), and/or an inactive communication mode (e.g., an RRC inactive mode) with the network node. Each mode may support various combinations of functionality at the UE. The UE may transition between different modes based at least in part on various commands and/or communications received from the network node.

In some examples, while the UE is in the idle communication mode or the inactive communication mode, the UE and the network node may implement a discontinuous reception (DRX) cycle to reduce power consumption. The DRX cycle may include a relatively long period during which the UE and/or the network node may enter a sleep mode. During the sleep mode, the UE may refrain from monitoring for communications and the network node may refrain from transmitting communications to the UE. The DRX cycle may additionally include a relatively short period during which the UE and/or the network node may enter an active mode. During the active mode, the UE may monitor for, and the network node may transmit, communications, such as a paging message, among other examples, and/or either entity may perform other operations, such as channel measurement, among other examples.

The network node may transmit a paging message to the UE during a paging occasion (e.g., one or more control channel monitoring occasions) of a paging frame (e.g., one paging frame may be one radio frame that contains one or more paging occasions or a starting point of a paging occasion) that is known to both the network node and the UE. The UE may transition to the active mode during one or more paging frames of the DRX cycle to monitor for paging messages. The network node may transmit the paging message to initiate a procedure for establishing an active communication link with the UE (e.g., via a random access channel procedure). The UE may identify a set of paging occasions and paging frames for entering the active mode during the DRX cycle based on an identifier (ID) of the UE. For example, each paging frame may be associated with a frame identifier (e.g., system frame number (SFN)) which may be calculated as a function of the UE ID. Each paging frame may occur during a frame having the associated frame identifier. Similarly, each paging occasion may be associated with an index that is calculated as a function of the UE ID. Each paging occasion may be a dedicated portion of the paging frame in which a paging message may be communicated. The UE may identify time resources in which the paging frames and paging occasions occur using the frame identifier and the paging occasion index. The UE may monitor the identified time resources for a potential paging message transmitted by the network node.

In some examples, a configuration of a DRX cycle may include a duration of the DRX cycle in some time unit (e.g., seconds, milliseconds, frames, subframes, symbols, slots, or another time unit), a quantity of paging frames per DRX cycle, and a quantity of paging occasions per paging frame of the paging cycle. The quantity of paging occasions may be evenly distributed throughout the DRX cycle. That is, the DRX cycle may include N paging frames that may be evenly spaced (e.g., in the time domain) over the duration of the DRX cycle (e.g., each paging frame in the DRX cycle may be separated from a next occurring paging frame by the same amount of time (e.g., the same quantity of frames or other time resource) in which the UE will be in the sleep mode).

Network energy saving (NES) and/or network energy efficiency measures are expected to have increased importance in wireless network operations for various reasons, such as climate change mitigation, environmental sustainability, and/or network cost reduction, among other examples. For example, although New Radio (NR) generally offers a significant energy efficiency improvement per gigabyte over previous generations (for example, long term evolution (LTE)), new NR use cases and/or the adoption of millimeter wave frequencies may require more network sites, more network antennas, larger bandwidths, and/or more frequency bands, among other examples, which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth the total cost to operate a wireless network, and over 90% of network operating costs are spent on energy (for example, fuel and electricity). The largest proportion of energy consumption and/or energy costs are associated with a radio access network (RAN), which accounts for about half of the energy consumption in a wireless network, with data centers and fiber transport accounting for smaller shares. Accordingly, measures to increase network energy savings and/or improve network energy efficiency are factors that may drive adoption and/or expansion of wireless networks. To further these measures, the network node and the UE may coordinate periods of operating in a sleep state such that the UE and the network node enter an active state to communicate during a same period of time.

In some examples, it may be beneficial for the DRX cycle to be configured with a set of N paging frames that are clustered together such that the UE and/or the network node may enter the sleep state for a longer consecutive duration. As used herein, “cluster of paging frames,” “clustered together,” or “clustering of paging frames” may refer to the paging frames having an asymmetrical distribution (e.g., in the time domain) within a DRX cycle. For example, a total time spent by a device (e.g., the UE and/or the network node) in the sleep state may be frontloaded before a clustered set of paging frames or backloaded after a clustered set of paging frames during the DRX cycle, rather than distributed in even portions throughout the DRX cycle. This may increase a total contiguous time spent by a device (e.g., the UE and/or the network node) in the sleep state when paging frames are clustered within a portion of a DRX cycle. However, the signaling of a new configuration for clustered paging frames may cause significant system information signaling overhead. For example, new definitions and adaptations of configuration parameters for clustered paging frames would require additional system information overhead for a clustered paging configuration in addition to a non-clustered paging configuration (e.g., a legacy configuration). Moreover, if the network node determines to change or adjust the non-clustered paging configuration and/or the clustered paging frame configuration, then the network node may update a system information block for the corresponding configuration. The network node updating and/or communicating the non-clustered paging configuration and/or the clustered paging frame configuration may consume network resources, increase signaling overhead, and/or may increase latency (e.g., introduce communication delays), among other examples.

Various aspects relate generally to indicating and configuring of a clustered paging frame configuration for a DRX cycle (e.g., each DRX cycle of a set of DRX cycles). For example, a network node may transmit, and a UE may receive, an indication of a set of parameters including a duration of the DRX cycle, and/or a quantity of paging frames per DRX cycle for a non-clustered paging configuration. Some aspects more specifically relate to configuring a clustered paging configuration from the non-clustered configuration. For example, based on receiving the indication, the UE may identify a clustered paging configuration, which may be derived from the non-clustered paging configuration. In some aspects, the UE may monitor for a paging message during at least one of the indicated paging frames according to at least one of the non-clustered paging configuration or the clustered paging configuration.

For example, the UE may derive a clustered paging frame by identifying an initial paging frame of the non-clustered paging configuration. The UE may identify that an initial paging frame of a clustered set of paging frames in the DRX cycle occupies a same set of time resources as the initial paging frame of the non-clustered paging configuration. In some aspects, the UE may receive a second set of one or more parameters (e.g., one or more of a paging frame offset, a duration of the DRX cycle, an indication of an equation for calculating paging frame numbers (e.g., SFN for paging frames), a quantity of paging frames per DRX cycle, a quantity of paging occasions per paging frame, among other examples, for the clustered paging configuration) with the parameters (e.g., a first set of one or more parameters (e.g., one or more of a paging frame offset, a duration of the DRX cycle, an indication of an equation for calculating paging frame numbers (e.g., SFN for paging frames, numbers identifying frames in which a paging message may be communicated), a quantity of paging frames per DRX cycle, a quantity of paging occasions per paging frame, among other examples) for the non-clustered paging configuration. The UE may determine, according to the non-clustered paging configuration, a set of paging frame numbers (e.g., SFN for paging frames, numbers identifying frames in which a paging message may be communicated) associated with the clustered set of paging frames using the second set of one or more parameters. In some aspects, the non-clustered paging frames and the clustered paging frames may be frequency division multiplexed and/or time-division multiplexed.

Particular aspects of the subject matter described in this disclosure can be implemented to realize one or more of the following potential advantages. In some examples, by receiving a set of one or more parameters for a non-clustered paging configuration, where the set of one or more parameters indicate a DRX cycle, and where the set of parameters are associated with a set of paging frames having a first distribution in the DRX cycle, the described techniques can be used to conserve transmission power and system information signaling overhead that would have otherwise been used to transmit explicit configuration information of a clustered paging configuration. In some examples, by monitoring for the paging message during at least one of the indicated paging frames according to at the clustered paging configuration, the UE and/or the network may conserve power by remaining in a sleep mode for a longer consecutive duration of time.

In some examples, by identifying an initial paging frame of the non-clustered paging configuration and identifying that an initial paging frame of the clustered set of paging frames in a DRX cycle occupies a same set of time resources as the initial paging frame of the non-clustered paging configuration, the UE may conserve resources by deriving the clustered paging configuration without additional protocols and/or signaling. In some examples, by calculating, according to the non-clustered paging configuration, a set of paging frame numbers associated with the clustered set of paging frames using the second set of parameters, the described techniques can be used to conserve memory resources and/or reduce signaling overhead. For example, the UE may conserve memory resources and/or reduce signaling overhead by reusing the methods for calculating the non-clustered paging configuration to calculate the clustered paging configuration using different values, which may increase flexibility of the clustered paging configuration with minimal impact to existing protocols. In some examples, by multiplexing the paging frames in time and/or frequency, the UE and/or the network may increase the likelihood that a paging message will be successfully communicated when both configurations are being implemented by avoiding potential collisions between clustered paging frames and non-clustered paging frames (e.g., overlapping scheduling).

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

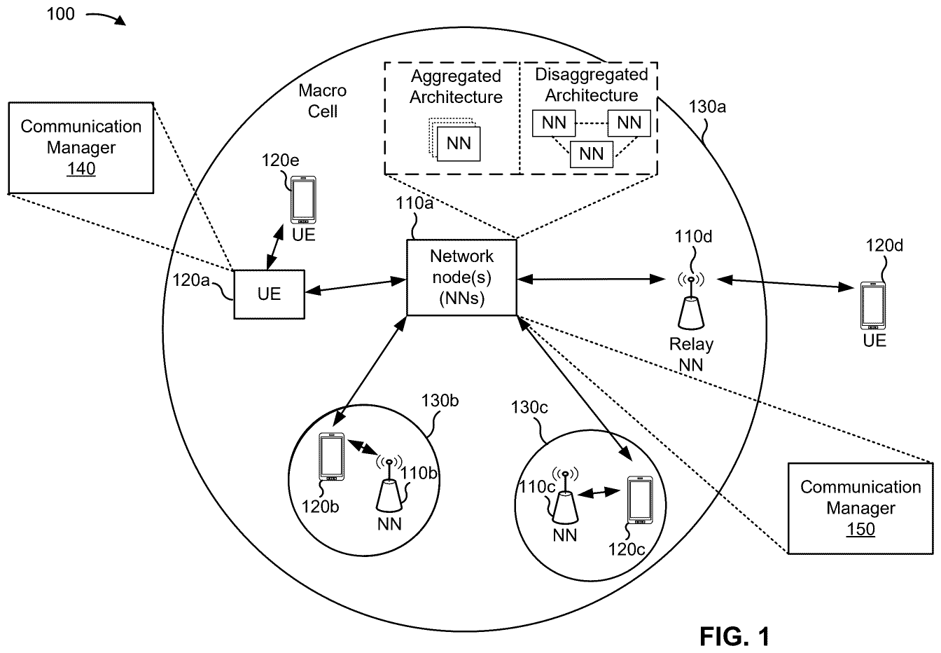

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally, or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally, or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally, or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport, and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network transmission, or non-coherent joint transmission (NC-JT).

In some examples, a UE 120 may implement power saving features, such as for UEs 120 in an RRC connected mode, an RRC idle mode, or an RRC inactive mode. Power saving features may include, for example, relaxed radio resource monitoring (such as for devices operating in low mobility or in good radio conditions), DRX, reduced PDCCH monitoring during active times, and/or power-efficient paging reception.

In some examples, a UE 120 may operate in association with a DRX configuration (for example, indicated to the UE 120 by a network node 110). DRX operation may enable the UE 120 to enter a sleep mode at various times while in the coverage area of a network node 110 to reduce power consumption for conserving battery resources, among other examples. The DRX configuration generally configures the UE 120 to operate in association with a DRX cycle. The UE 120 may repeat DRX cycles with a configured periodicity according to the DRX configuration. A DRX cycle may include a DRX on duration during which the UE 120 is in an awake mode or in an active state. A DRX cycle may also include one or more durations during which the UE 120 may operate in an inactive state. The one or more durations may be opportunities for the UE 120 to enter a DRX sleep mode in which the UE 120 may refrain from monitoring for communications from a network node 110. Additionally or alternatively, the UE 120 may deactivate one or more antennas, RF chains, and/or other hardware components or devices while operating in the DRX sleep mode.

The time during which the UE 120 is configured to be in an active state during a DRX on duration may be referred to as an active time, and the time during which the UE 120 is configured to be in an inactive state, such as during a DRX sleep duration, may be referred to as an inactive time. During a DRX on duration, the UE 120 may monitor for downlink communications from one or more network nodes 110. If the UE 120 does not detect and/or does not successfully decode any downlink communications during the DRX on duration, the UE 120 may enter a DRX sleep mode for the inactive time duration at the end of the DRX on duration. If the UE 120 detects and/or successfully decodes a downlink communication during the DRX on duration, the UE 120 may remain in the active state for the duration of a DRX inactivity timer (which may extend the active time). The UE 120 may start the DRX inactivity timer at a time at which the downlink communication is received. The UE 120 may remain in the active state until the DRX inactivity timer expires, at which time the UE 120 may transition to the sleep mode for an inactive time duration. Additionally or alternatively, the UE 120 may use a DRX cycle referred to as an extended DRX (eDRX) cycle, such as for use cases that are tolerant to latency. An eDRX cycle may include a relatively longer inactive time relative to a baseline DRX cycle (for example, an eDRX cycle may have a lower ratio of active time to inactive time).

In some aspects, the UE 120 may include a communication manager 140. As described in more detail elsewhere herein, the communication manager 140 may receive a set of parameters for a first paging configuration, wherein the set of parameters indicate a DRX cycle, and wherein the set of parameters are associated with a set of paging frames having a first distribution in the DRX cycle; and monitor for a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution. Additionally, or alternatively, the communication manager 140 may perform one or more other operations described herein.

In some aspects, the network node 110 may include a communication manager 150. As described in more detail elsewhere herein, the communication manager 150 may transmit, to a UE, a set of parameters for a first paging configuration, wherein the set of parameters indicate a DRX cycle, and wherein the set of parameters are associated with a set of paging frames having a first distribution in the DRX cycle; and transmit a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution. Additionally, or alternatively, the communication manager 150 may perform one or more other operations described herein.

As indicated above, FIG. 1 is provided as an example. Other examples may differ from what is described with regard to FIG. 1.

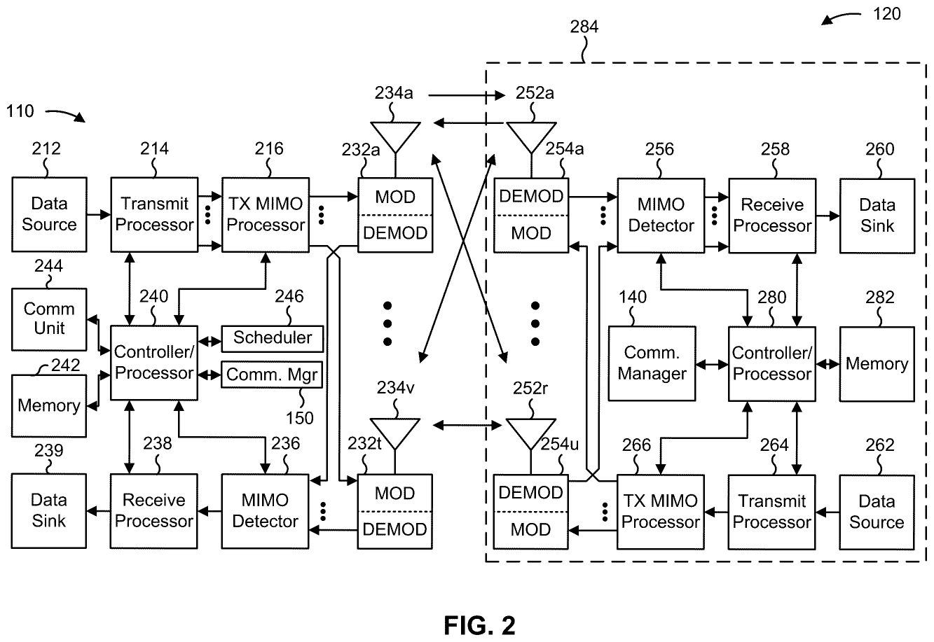

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

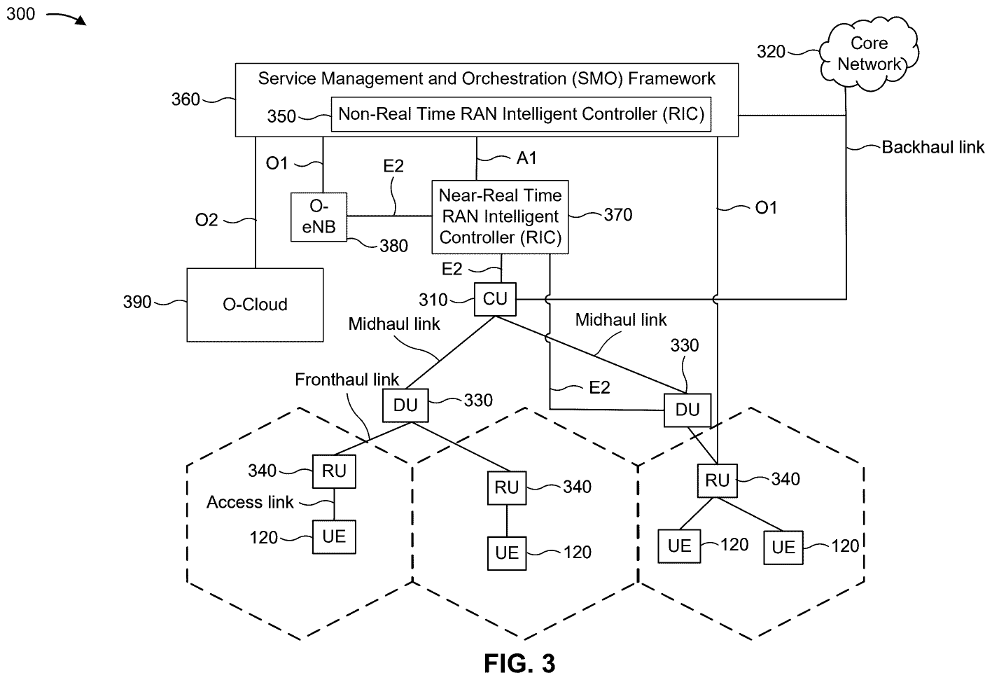

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally, or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

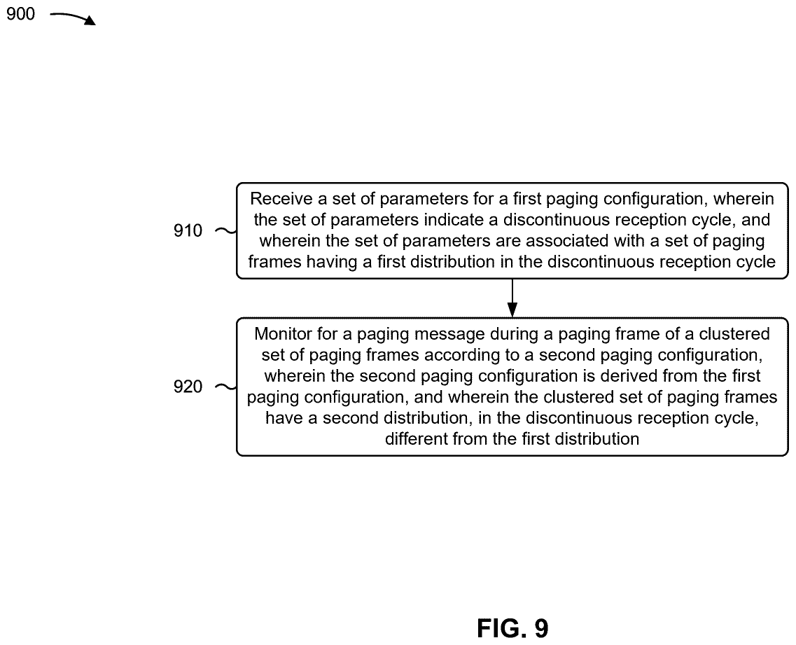

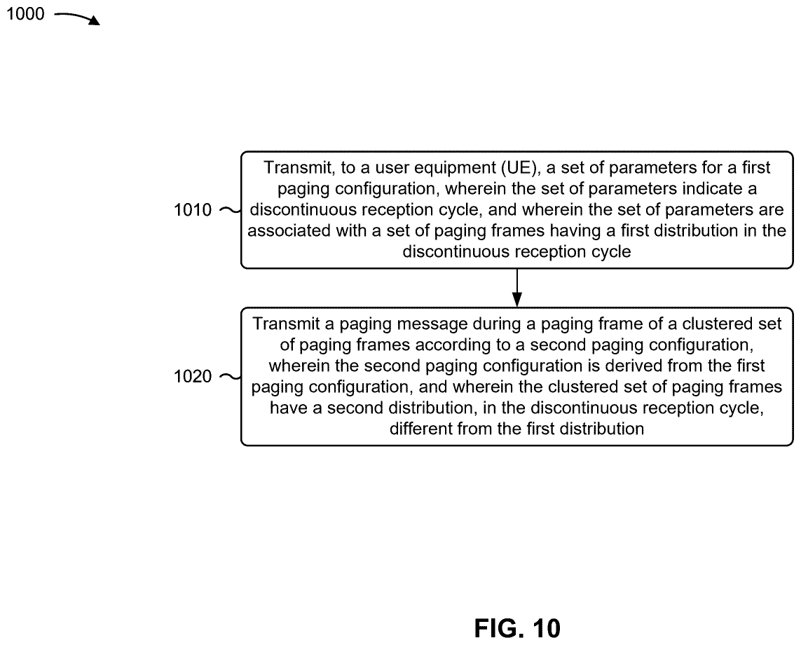

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with indicating and/or configuring clustered paging, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, method 900 of FIG. 9, method 1000 of FIG. 10, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform method 900 of FIG. 9, method 1000 of FIG. 10, or other processes as described herein. In some examples, executing instructions may include running the instructions, converting the instructions, compiling the instructions, and/or interpreting the instructions, among other examples.

In some aspects, the UE 120 includes means for receiving a set of parameters for a first paging configuration, wherein the set of parameters indicate a DRX cycle, and wherein the set of parameters are associated with a set of paging frames having a first distribution in the DRX cycle; and/or means for monitoring for a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE, a set of parameters for a first paging configuration, wherein the set of parameters indicate a DRX cycle, and wherein the set of parameters are associated with a set of paging frames having a first distribution in the DRX cycle; and/or means for transmitting a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

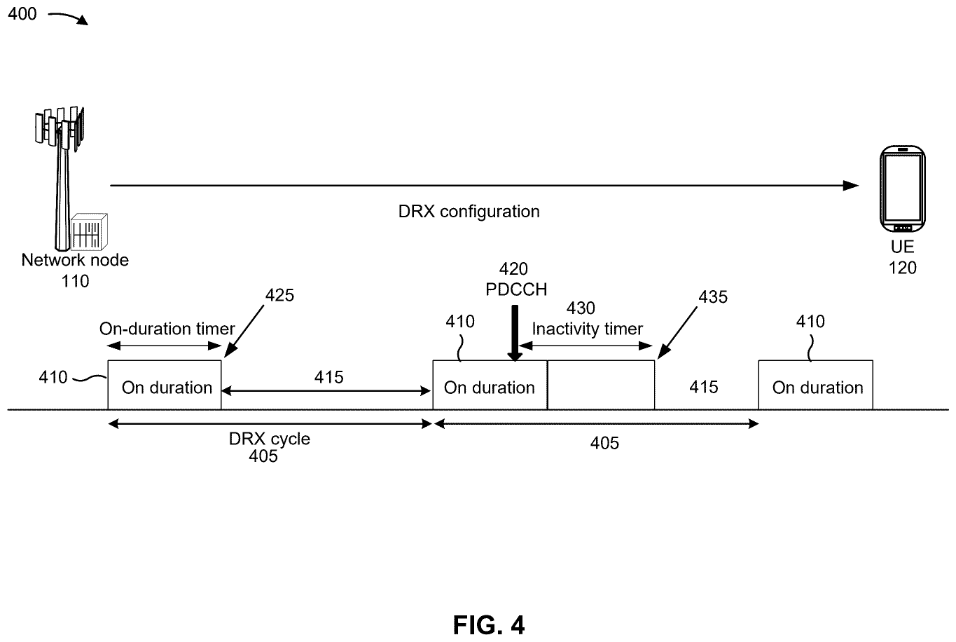

FIG. 4 is a diagram illustrating an example 400 of a DRX configuration, in accordance with the present disclosure.

As shown in FIG. 4, a network node 110 may transmit a DRX configuration to a UE 120 to configure a DRX cycle 405 for the UE 120. A DRX cycle 405 may include a DRX on duration 410 (e.g., during which a UE 120 is awake or in an active state) and an opportunity to enter a DRX sleep state 415. As used herein, the time during which the UE 120 is configured to be in an active state during the DRX on duration 410 may be referred to as an active time, and the time during which the UE 120 is configured to be in the DRX sleep state 415 may be referred to as an inactive time. In some examples, the active time may coincide with one or more paging frames. As described below, the UE 120 may monitor a PDCCH during the active time. Additionally, during the active time, the UE 120 may monitor for a paging message, as described herein, during a paging occasion (e.g., a portion of the paging frame which may be reserved specifically for the paging message) of a paging frame occurring during the DRX on duration 410. The UE 120 may refrain from monitoring the PDCCH or from monitoring for a paging message during the inactive time.

During the DRX on duration 410 (e.g., the active time), the UE 120 may monitor a downlink control channel (e.g., a PDCCH), as shown by reference number 420. For example, the UE 120 may monitor the PDCCH for downlink control information (DCI) pertaining to the UE 120. If the UE 120 does not detect and/or successfully decode any PDCCH communications intended for the UE 120 during the DRX on duration 410, then the UE 120 may enter the sleep state 415 (e.g., for the inactive time) at the end of the DRX on duration 410, as shown by reference number 425. In this way, the UE 120 may conserve battery power and reduce power consumption. As shown, the DRX cycle 405 may repeat with a configured periodicity according to the DRX configuration.

If the UE 120 detects and/or successfully decodes a PDCCH communication intended for the UE 120, then the UE 120 may remain in an active state (e.g., awake) for the duration of a DRX inactivity timer 430 (e.g., which may extend the active time). The UE 120 may start the DRX inactivity timer 430 at a time at which the PDCCH communication is received (e.g., in a transmission time interval (TTI) in which the PDCCH communication is received, such as a slot or a subframe). The UE 120 may remain in the active state until the DRX inactivity timer 430 expires, at which time the UE 120 may enter the sleep state 415 (e.g., for the inactive time), as shown by reference number 435. During the duration of the DRX inactivity timer 430, the UE 120 may continue to monitor for PDCCH communications, may obtain a downlink data communication (e.g., on a downlink data channel, such as a physical downlink shared channel (PDSCH)) scheduled by the PDCCH communication, and/or may prepare and/or transmit an uplink communication (e.g., on a physical uplink shared channel (PUSCH)) scheduled by the PDCCH communication. The UE 120 may restart the DRX inactivity timer 430 after each detection of a PDCCH communication for the UE 120 for an initial transmission (e.g., but not for a retransmission). By operating in this manner, the UE 120 may conserve battery power and reduce power consumption by entering the sleep state 415.

In some examples, the UE 120 may receive, and the network node 110 may transmit, an indication of a set of parameters including a duration of the DRX cycle 405 and/or a quantity of paging frames per DRX cycle 405 for the DRX configuration. In some aspects, the UE 120 may determine a second (e.g., different) DRX configuration based on the DRX configuration. In some aspects, the second DRX cycle may enable the UE 120 to spend longer contiguous durations in the sleep state 415 by clustering occasions potentially spent in the DRX on duration 410. By deriving the second DRX configuration from the DRX configuration, the UE 120 may experience the power-saving benefits of the second DRX cycle with relatively little to no additional overhead.

Additionally, by coordinating a sleep schedule with the UE 120, the network node 110 may experience the power-saving benefits of the second DRX cycle being implemented by the UE 120 and the network node 110 with relatively little to no additional signaling overhead at the UE 120. For example, by implementing the second DRX cycle, the network node 110 and the UE 120 may experience overlapping periods of operating in a sleep state such that the UE 120 and the network node 110 enter an active state to communicate during a same period of time, thereby saving energy and supporting measures to increase network energy savings and/or improve network energy efficiency.

As indicated above, FIG. 4 is provided as an example. Other examples may differ from what is described with respect to FIG. 4.

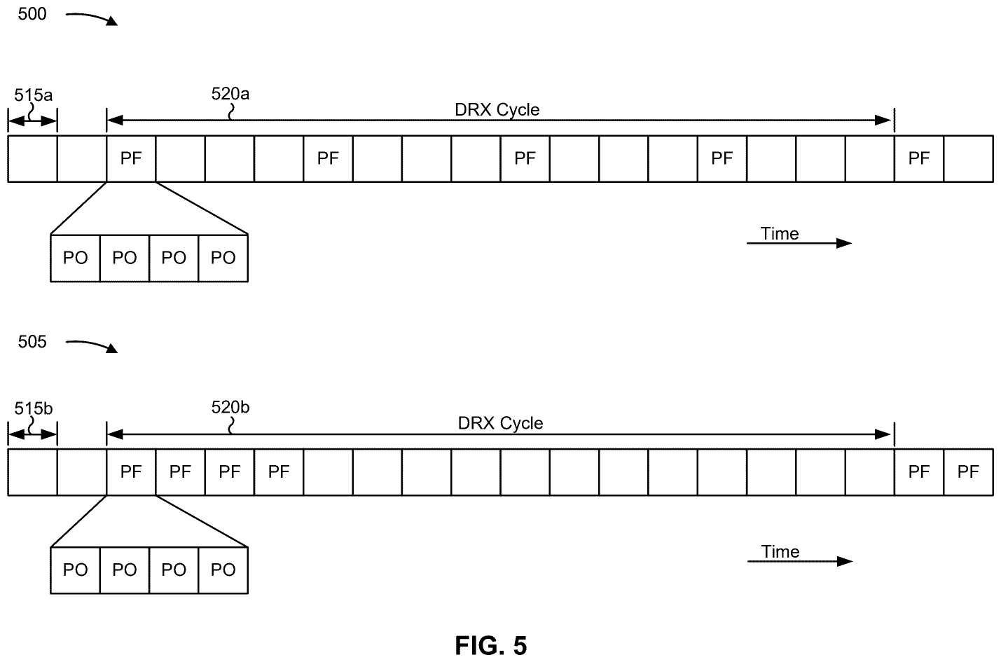

FIG. 5 is a diagram illustrating an example 500 of a first paging configuration and an example 505 of a second paging configuration, in accordance with the present disclosure.

The example 500 and the example 505 each depict resources for communicating messages by a UE (e.g., a UE 120) and/or a network node (e.g., network node 110) in the context of a wireless communications system (e.g., wireless communications system 100).

The example 500 of the first paging configuration illustrates a configuration for non-clustered paging, as described herein, and includes a DRX cycle 520a. For example, the UE may use DRX in an RRC idle (e.g., RRC_IDLE) and/or an RRC inactive (RRC_INACTIVE) state (e.g., mode of operation) to reduce power consumption. The UE may monitor one or more paging occasions (POs) per DRX cycle 520a. In some examples, a PO may include a set of control channel (e.g., PDCCH) monitoring occasions and may include multiple time intervals (e.g. multiple slots, subframes, or OFDM symbols) where a paging message (e.g., paging DCI) may be transmitted. The example 500 of the first paging configuration may include one or more paging frames (PFs), where a single PF may be a single radio frame 515a or may be another unit of time or time resource. For example, a single PF may include one or more subframes, one or more slots, and/or one or more symbols, among other examples. Each radio frame may have a predetermined duration (e.g., 10 milliseconds (ms)) and may be partitioned into a set of one or more subframes. Each subframe may have a predetermined duration (e.g., 1 ms) and may include a set of one or more slots (e.g., 2m slots per subframe, where m is an index of a numerology used for a transmission, such as 0, 1, 2, 3, 4, or another number). Each slot may include a set of L symbol periods (e.g., OFDM symbols). For example, each slot may include fourteen symbol periods, seven symbol periods, or another number of symbol periods.

Each PF may include one or more POs or a starting point of a PO. For example, as shown in the example 500, the DRX cycle 520a may include four PFs, where each PF includes four POs. Each paging occasion may include a quantity of slots in which corresponding synchronization signal blocks (SSBs) may be received by the UE and transmitted by the network node (e.g., a single SSB may be transmitted during a given PO). A portion of each slot of the PO may be reserved for a control channel (e.g., PDCCH) monitoring occasion. A UE operating according to the first paging configuration may operate in an active mode (e.g., may monitor for incoming transmissions and/or may perform other operations, such as channel measurement) during the PFs, and may operate according to a sleep mode (e.g., may not monitor for incoming transmissions and/or may not perform other operations) during the remaining radio frames 515a of the DRX cycle 520a.

The example 500 depicts a non-clustered paging configuration. For example, each PF of the DRX cycle in the first paging configuration may be evenly distributed throughout the DRX cycle (e.g., not grouped together in an asymmetric manner). That is, each PF may be separated from a subsequently occurring PF by a given quantity of radio frames 515a (e.g., three as shown in the example 500) in which the UE will operate in the sleep mode. In the example 500, a UE operating according to the first configuration may spend a total of 12 frames in the sleep mode during the DRX cycle 520a. However, the 12 frames may be interspersed with PFs, and the UE may transition to the sleep mode four times during the DRX cycle 520a.

The UE may determine the PF and the PO using various parameters and equations. For example, the UE 120 may calculate the SFN for each PF to identify which frames to monitor for the paging message by using an equation of the form:

$$SFN for paging frame ( PF ) : ( SFN + P {F}_{offset} ) mod ( T ) = \frac{T}{N} ( UEID mod ( N ) ) \qquad [ 1 ]$$

where: SFN is the system frame number; PFoffset is a quantity of frames by which a PF is offset (e.g., offset used for PF determination); T is the duration of the DRX cycle; Nis the quantity of paging frames per DRX cycle; and UEID is a unique identifier of the UE (e.g., UE ID). In some examples, the UE ID may be a permanent identifier such as a subscriber concealed identifier (SUCI), a permanent identifier such as a subscriber permanent identifier (SUPI), a 5G globally unique temporary identifier (5G-GUTI), or any other unique identifier of the UE. Further, the UE may calculate the paging occasion index to identify which subslots (e.g., PDCCH monitoring occasions) of the PF to monitor for paging messages by using an equation of the following form:

$$PO index : {N}_{s} = floor ( \frac{UEID}{N} ) mod {N}_{s} \qquad [ 2 ]$$

where iₛ is the paging occasion index; and Nₛ is the quantity of paging occasions per paging frame.

The UE may receive or otherwise identify the parameters for the first paging configuration via a configuration message (via one or more of system information signaling (e.g., a master information block (MIB) and/or a system information block (SIB), among other examples), RRC signaling, MAC signaling (e.g., one or more MAC control elements (MAC-CEs)), and/or DCI, among other examples).

The example 505 of the second paging configuration illustrates a configuration for clustered paging, as described herein, and includes a DRX cycle 520b. Similarly to example 500, the UE may use DRX in an RRC_IDLE and/or an RRC_INACTIVE state (e.g., mode of operation) to reduce power consumption. The UE may monitor one or more paging occasions (POs) per DRX cycle 520b. Likewise, as described similarly in connection with the example 500, a PO may include a set of PDCCH monitoring occasions and may include multiple time slots (e.g. multiple subframes or OFDM symbols) where a paging message (e.g., paging downlink control information (DCI) may be transmitted. The example 505 of the second paging configuration may include one or more PFs (e.g., PFs similar to those described in connection with example 500). For example, in the example 505, the DRX cycle 520b may include four PFs, where each PF includes four POs. A UE operating according to the second paging configuration may operate in an active mode (e.g., similar to the corresponding description provided in connection with example 500) during the PFs, and may operate according to a sleep mode (e.g., similar to the corresponding description provided in connection with example 500) during the remaining radio frames 515b of the DRX cycle 520b.

The example 505 depicts a clustered paging configuration. For example, the PFs of the DRX cycle 520b in the second paging configuration may be unevenly (e.g., asymmetrically) distributed throughout the DRX cycle 520b (e.g., grouped together in the time domain in an asymmetric manner). That is, the PFs may occur starting with a first PF and then may be separated from a subsequently occurring PF by an integer quantity x of radio frames 515b (e.g., during each of which the UE may operate in the sleep mode) until the last paging frame after which no more paging frames occur during the DRX cycle 520b. In the example 505, x=0 and the UE may operate in the active mode for four consecutive (e.g., in this case contiguous) radio frames 515b. The UE may operate in the sleep mode for the remaining radio frames 515b of the DRX cycle 520b. Therefore, the UE may spend a total of 12 radio frames 515b in the sleep mode during the DRX cycle 520b. However, because example 505 includes clustered paging frames, the 12 radio frames 515b may be contiguous and the UE may transition to the sleep mode once during the DRX cycle 520b. The network node and the UE may coordinate periods of operating in the sleep mode such that the UE and the network node enter an active state to communicate during a same period of time. This coordination may lead to increased network energy savings and/or improve network energy efficiency are factors that may drive adoption and/or expansion of wireless networks. In other examples, the value of x may be greater than zero (and, for example, x radio frames 515b may be between each PF). Although the example 505 shows the first PF (e.g., first in the time domain) occurring at the first radio frame 515b included in the DRX cycle 520b (e.g., the first PF occurring at the start of the DRX cycle 520b), in other examples, the first PF may occur at a different time domain location (e.g., a different radio frame 515b) during the duration of the DRX cycle 520b.

“Asymmetric” or “clustered” as used in the context of paging configurations refers to an uneven distribution (e.g., in the time domain) of PFs in which a contiguous set of frames in which the UE may operate in the sleep mode during the DRX cycle may be larger than x. For example, in the example of DRX cycle 520b, the PFs are front loaded in the beginning of the DRX cycle 520b. However, “clustered” may also refer to a backloaded distribution or a cluster of PFs in the middle of a DRX cycle. “Evenly distributed” or “non-clustered” as used in the context of paging configurations may refer to a distribution of PFs in which a contiguous set of frames in which the UE may operate in the sleep mode during the DRX cycle is the same as the quantity of frames between each PF. For example, in the DRX cycle 520a, the PFs are evenly spaced through the duration of the DRX cycle 520a and each period of operating in the sleep mode includes the same quantity of radio frames.

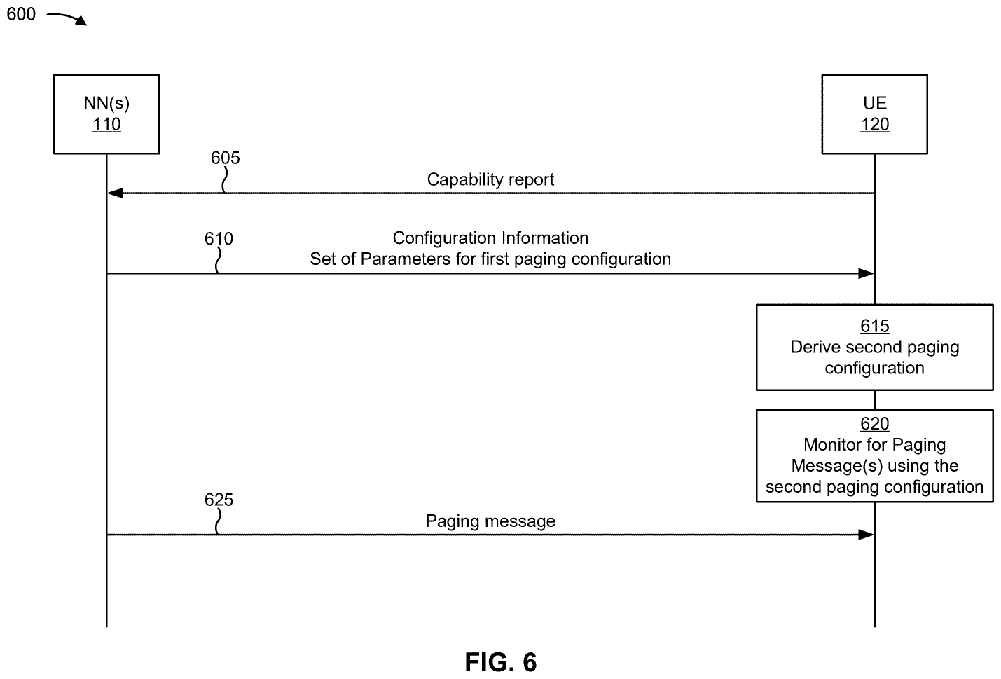

Methods for receiving or otherwise identifying parameters for the second paging configuration are described in more detail elsewhere herein, such as in connection with FIGS. 6-10.

As indicated above, FIG. 5 is provided as an example. Other examples may differ from what is described with respect to FIG. 5.

FIG. 6 is a diagram of an example 600 associated with configuring and/or indicating a clustered paging configuration, in accordance with the present disclosure. As shown in FIG. 6, a network node (e.g., network node 110, a CU, a DU, and/or an RU) may communicate with a UE (e.g., UE 120). In some aspects, the network node 110 and the UE 120 may be part of a wireless network (e.g., the wireless communication network 100). The UE 120 and the network node 110 may have established a wireless connection prior to operations shown in FIG. 6.

As shown by reference number 605, the UE 120 may transmit, and the network node 110 may receive, a capability report. The UE 120 may transmit the capability report via an uplink communication, a UE assistance information (UAI) communication, an uplink control information (UCI) communication, an uplink MAC control element (MAC-CE) communication, an RRC communication, a physical uplink control channel (PUCCH), and/or a physical uplink shared channel (PUSCH), among other examples. The capability report may include capability information that is indicative of whether the UE 120 supports a feature and/or one or more parameters related to the feature. The capability report may indicate one or more parameters associated with respective capabilities of the UE 120. The one or more parameters may be indicated via respective information elements (IEs) included in the capability report.

The capability report may indicate whether the UE 120 supports a feature and/or one or more parameters related to the feature. For example, the capability report may indicate a capability and/or parameter for monitoring for a paging message according to a clustered paging configuration. As another example, the capability report may indicate a capability and/or parameter for determining (e.g., deriving and/or calculating) one or more paging configurations (e.g., a clustered paging configuration and/or a non-clustered paging configuration). One or more operations described herein may be based on capability information of the capability report. For example, the UE 120 may perform a communication in accordance with the capability information, or may receive configuration information that is in accordance with the capability information. In some aspects, the capability report may indicate UE support for identifying a clustered paging configuration that may inform or support clustered paging by the network node 110. “Clustered,” as used herein in connection with paging frames, refers to an asymmetric distribution, an uneven distribution, a clumped distribution, or a conglomeration of paging frames, in the time domain, within a single DRX cycle as described with reference to FIG. 5.

As shown by reference number 610, the network node 110 may transmit, and the UE 120 may receive, configuration information. In some aspects, the UE 120 may receive the configuration information via one or more of system information signaling (e.g., a MIB and/or a SIB, among other examples), RRC signaling, MAC signaling (e.g., one or more MAC-CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may indicate that the UE 120 is to use a set of parameters received in the configuration information to identify or determine (e.g., identify, derive, or calculate parameters of) a non-clustered paging configuration, and derive or otherwise calculate a clustered paging configuration, as described herein. For example, as shown by reference number 610, the network node 110 may transmit, and the UE 120 may receive, a set of parameters for a first paging configuration (e.g., non-clustered paging configuration). The set of parameters may indicate a DRX cycle. For example, the configuration information may include a DRX configuration (e.g., in a similar manner as described in connection with FIG. 4). The set of parameters may be associated with a set of paging frames having a first distribution (e.g., in the time domain) in the DRX cycle. The network node 110 may transmit the set of parameters for the first paging configuration via system information signaling, such as via remaining minimum system information (RMSI) signaling and/or via a SIB1 (e.g., as defined, or otherwise fixed, by a wireless communication standard, such as the 3GPP).

In some aspects, the set of parameters may indicate a quantity of paging frames in the DRX cycle and a quantity of paging occasions per paging frame of the first paging configuration. For example, the set of parameters may include an explicit indication of N (e.g., quantity of paging frames per DRX cycle, as described herein), Ns (e.g., the quantity of paging occasions per paging frame), and a paging frame offset (e.g., PFoffset) (e.g., indicating a number of frames that a paging frame is offset by) for the first (e.g., non-clustered) paging configuration in the configuration information. In such examples, the set of parameters may include an indication of an integer interval of x paging frames (e.g., within the DRX cycle) between paging frames occurrences.

In some aspects, the set of parameters may include a second set of parameters. The second set of parameters may be associated with (e.g., specific to) a second paging configuration (e.g., a clustered paging configuration). For example, the second set of parameters may include an explicit indication of N (e.g., quantity of paging frames per DRX cycle, as described herein), Ns (e.g., the quantity of paging occasions per paging frame), and/or paging frame offset (e.g., PFoffset) (e.g., indicating a number of frames that a PF is offset by) for the clustered paging configuration (e.g., the clustered paging configuration) in the configuration information.

For example, the network node 110 may transmit an indication of the set of parameters via a configuration IE. The configuration IE may be a SIB IE, such as a common downlink configuration IE (e.g., a DownlinkConfigCommonSIB as defined, or otherwise fixed, by a wireless communication standard, such as the 3GPP). The set of parameters may be indicated via a control channel configuration IE within the common downlink configuration IE. The control channel configuration IE may be a PCCH-Config IE (e.g., as defined, or otherwise fixed, by a wireless communication standard, such as the 3GPP). For example, the indication of N, Ns, and the PFoffset may be indicated via one or more fields or IEs within the control channel configuration IE. For example, the indication of N and the PFoffset may be indicated via an nAndPagingFrameOffset IE (e.g., as defined, or otherwise fixed, by a wireless communication standard, such as the 3GPP). Similarly, the indication of Ns may be indicated via an Ns IE within the PCCH-Config IE.

The UE 120 may configure itself based at least in part on the configuration information. In some aspects, the UE 120 may be configured to perform one or more operations described herein based at least in part on the configuration information.

In some aspects, the configuration information described in connection with reference number 610 and/or the capability report described in connection with reference number 605 may include information transmitted via multiple communications. Additionally, or alternatively, the network node 110 may transmit the configuration information, or a communication including at least a portion of the configuration information, before and/or after the UE 120 transmits the capability report. For example, the network node 110 may transmit a first portion of the configuration information before the capability report, the UE 120 may transmit at least a portion of the capability report, and the network node 110 may transmit a second portion of the configuration information after receiving the capability report. The UE 120 may determine (e.g., identify, derive calculate) the first paging configuration using information received in the configuration information.

As shown by reference number 615, the UE 120 may determine (e.g., derive, calculate parameters of, or select from a plurality of options) a second paging configuration (e.g., a clustered paging configuration) using, from, based on, or otherwise associated with the first paging configuration. In some aspects, the first paging configuration and/or the second paging configuration may be derived from an identifier of the UE 120. The first paging configuration and the second paging configuration may be associated with a DRX configuration (e.g., the same DRX configuration). The UE 120 may perform one or more calculations as a function of the UE ID to determine one or more paging frame SFNs for the first paging configuration and/or the second paging configuration. The second paging configuration may include, or otherwise indicate, a clustered set of paging frames. In some aspects, paging frames of the clustered set of paging frames may occur at an integer interval of x paging frames (e.g., within the DRX cycle). For example, the clustered set of paging frames may occur during a portion of the DRX cycle, and may occur at an integer interval of paging frames rather than contiguously, but may still be unevenly distributed through the DRX cycle as a whole. For example, x having a value of zero may indicate that the clustered set of paging frames are contiguous in time. In some aspects, x may be indicated in the set of parameters (e.g., via SIB1).

In some aspects, each of the first paging configuration and the second paging configuration may be associated with different contiguous durations in which the UE 120 and/or the network node are operating in the sleep state. For example, the first distribution of paging frames (e.g., non-clustered paging frames) of the first paging configuration may be associated with a first sleep state duration. The second distribution of paging frames (e.g., clustered paging frames) of the second paging configuration may be associated with a second sleep state duration. The first sleep state duration may be shorter than the second sleep state duration. In some aspects, the first distribution may be uniform (e.g., non-clustered) over the duration of the DRX cycle, and the second distribution may be non-uniform (e.g., clustered) over the duration of the DRX cycle. For example, “uniform distribution” may refer to an even distribution of paging frames in time (e.g., occurring every n time units (e.g., frames, subframes, slots, among other examples) over the duration of the DRX cycle. “Non-uniform distribution” may refer to an uneven distribution of paging frames in time (e.g., starting at a first paging frame and then occurring every x time units over the duration of the DRX cycle (e.g., slots, frames, subframes, symbols, or other), where the value of x results in the paging frames being unevenly spread in the time domain over the duration of a given DRX cycle (e.g., as depicted in FIGS. 5, 6, and 7).

In some aspects, the clustered set of paging frames may occupy a set of time resources that is a proper subset of time resources of the DRX cycle. In some aspects, the first distribution may include a spacing of the set of paging frames, in time, that is derived from a duration of the DRX cycle. The second distribution may include a spacing of the clustered set of paging frames, in time, that is derived from a length of a time interval within the DRX cycle. For example, a duration of the clustered paging frames (e.g., a duration from a first occurring paging frame to a last occurring (e.g., in time) paging frame) may occur in a portion of the DRX cycle that leaves an integer multiple of the total DRX cycle for the sleep mode. For example, a total duration of the DRX cycle may include 16 frames and a duration of the clustered paging frames of the DRX cycle may include 2, 4, 8, or 12 frames from the occurrence of the first paging frame to the last paging frame of the cluster depending on the value of x and the quantity of paging frames in the cluster.

In some aspects, paging frames of the set of paging frames (e.g., paging frames of the first configuration) may occur at a second interval of paging frames that is different from x. For example, the set of paging frames associated with the first paging configuration (e.g., the non-clustered paging configuration) may be evenly distributed (e.g., in the time domain) throughout the DRX cycle at an integer interval of paging frames different than x. The integer interval of paging frames for the first paging configuration may be indicated in the set of parameters (e.g., transmitted by the network node 110 as described in connection with reference number 610).

In some aspects, the quantity of paging occasions per paging frame of the first paging configuration (e.g., the non-clustered paging configuration) may be the same quantity as a quantity of paging occasions per paging frame of the second paging configuration (e.g., the clustered paging configuration). For example, the UE 120 may receive an indication of Ns for the first paging configuration (e.g., in the set of parameters described in connection with reference number 610) and may identify that the Ns for the second paging configuration is to be the same as the Ns for the first paging configuration.

In some aspects, an initial paging frame of the clustered set of paging frames in the DRX cycle associated with the second paging configuration may occupy the same set of time resources as an initial paging frame of the set of paging frames according to the first paging configuration. For example, the UE 120 may identify an SFN for a first paging frame associated with the first paging configuration in a non-clustered set of paging frames (e.g., using the set of parameters indicated by the configuration information). The UE 120 may determine (e.g., calculate or derive) that the SFN for a first paging frame associated with the second paging configuration (e.g., in a clustered set of paging frames) is the same as the SFN for the first paging frame associated with the first paging configuration. The UE 120 may determine (e.g., derive) the SFNs for the remaining clustered paging frames associated with the second paging configuration for the DRX cycle based on, or otherwise associated with, the value of x. For example, if x is indicated as having a value of 1, the UE 120 may determine that the first clustered paging frame has an SFN of n, the second clustered paging frame has an SFN of n+1, and so on. As another example, if the value of x is 0 (zero), then the UE 120 may determine that the paging frames for the second paging configuration (e.g., the clustered paging frames) are consecutive in the time domain.

In some aspects, the UE 120 may receive the set of parameters, as described in connection with reference number 610, in a SIB (e.g., SIB1) and the UE 120 may derive the second paging configuration (e.g., the clustered paging configuration) without receiving additional configuration information (e.g., an updated SIB) that indicates the second paging configuration. For example, the UE 120 may use the values received in the SIB to derive the second paging configuration in a similar manner as the UE 120 derives the first paging configuration, as described elsewhere herein (e.g., FIGS. 5, 7, and 8)

In some aspects, as described above, the UE 120 may receive, and the network node 110 may transmit, a second set of parameters along with the set of parameters for the first paging configuration (e.g., as described in connection with reference number 610). For example, the UE 120 may receive an explicit indication of N (e.g., quantity of paging frames per DRX cycle as described herein), Ns (e.g., the quantity of paging occasions per paging frame), and/or PFoffset (e.g., indicating a number of frames that a paging frame is offset by) for the second paging configuration (e.g., the clustered paging configuration) in the configuration information, as described in connection with reference number 610.

In some examples, the UE 120 may determine, according to the first paging configuration, a set of paging frame numbers associated with a clustered set of paging frames using the second set of parameters, as shown by reference number 615. For example, to determine the paging frames (e.g., to identify the paging frame numbers for the clustered set of paging frames) for the clustered paging configuration, the UE 120 may use the clustering-specific values of N and PFoffset (e.g., indicated via the configuration information, such as in SIB1) to determine the paging frames according to the methods used to calculate the paging frames for the first (e.g., non-clustered) paging configuration (e.g., as described with reference to FIGS. 4 and 5). This may conserve resources by reusing the methods for determining the first configuration to determine the second configuration and may increase the flexibility of the second configuration with minimal signaling overhead.

In some aspects, the set of (non-clustered) paging frames and the clustered set of paging frames may be multiplexed with one another (e.g., may at least partially share or use common radio resources). For example, radio resources of at least one paging frame from the set of non-clustered paging frames may at least partially overlap in the time domain and/or the frequency domain with radio resources of at least one paging frame from the set of clustered paging frames.

For example, one or more of the set of (non-clustered) paging frames and one or more of the clustered set of paging frames may be frequency division multiplexed. In such aspects, there may be a frequency offset between the non-clustered paging frame(s) and the clustered set of paging frame(s). In some aspects, an indication of the frequency offset may be received with the set of parameters, as described in connection with reference number 610. In other aspects, the frequency offset may be fixed (e.g., defined, specified) in a wireless communication specification. In other aspects, the frequency offset may be equal to a paging occasion frequency bandwidth associated with the first paging configuration. In some aspects, the UE 120 may receive an indication of a frequency offset between the set of paging frames and the clustered set of paging frames. For example, based on receiving the indication of the frequency offset, the UE 120 may apply a frequency offset to the clustered set of paging frames such that the clustered set of paging frames and the non-clustered set of paging frames may at least partially share common time domain resources, but not overlap in the frequency domain.

Additionally, or alternatively, one or more of the set of (non-clustered) paging frames and one or more of the clustered set of paging frames may be time division multiplexed with one another. In such aspects, a paging frame of the set of paging frames may at least partially overlap with a clustered paging frame of the clustered set of paging frames in the frequency domain. In such examples, the UE 120 may perform one or more actions to increase reliability, as described below.

As shown by reference number 620, the UE 120 may monitor for a paging message during a paging frame of the clustered set of paging frames according to the second paging configuration. In some aspects, the clustered set of paging frames may have a second distribution, in the DRX cycle, that is different from the first distribution of the set of paging frames (e.g., associated with the first paging configuration). For example, according to the first distribution and/or the second distribution of paging frames, the UE 120 may be in an active state for a first portion of the DRX cycle (e.g., to perform monitoring) and may be in a sleep state for a second portion of the DRX cycle.

In some aspects, when the set of (non-clustered) paging frames and the clustered set of paging frames are time division multiplexed with one another, as described above, the UE 120 may monitor for the paging message during the overlapped clustered paging frame(s) on a first one or more frequency resources having the frequency offset (e.g., as described above) with respect to a second one or more frequency resources of the paging frame of the set of (non-clustered) paging frames. As described, in such aspects, an indication of the frequency offset may be included in the set of parameters, the frequency offset may be fixed, or the frequency offset may be equal to a paging occasion frequency bandwidth associated with the first paging configuration. In some aspects, when the set of paging frames and the clustered set of paging frames are time division multiplexed with one another, the UE 120 may drop (e.g., refrain from monitoring or receiving) a paging frame from the clustered set of paging frames that at least partially overlaps in the time domain with a paging frame from the set of non-clustered paging frames. For example, in some aspects, the UE 120 may identify an overlap (e.g., in the time domain) between a paging frame of the set of paging frames and the paging frame of the clustered set of paging frames as an error case.

According to the first paging configuration, the UE 120 may enter the sleep state between evenly distributed paging frames, and therefore a total time spent in the sleep state may occur in discrete, equal portions of time throughout the DRX cycle. According to the second paging configuration, the UE 120 may enter a prolonged sleep state (e.g., in addition to any intermediate sleep state entered during the integer interval spacing of clustered paging frames, x) before or after the unevenly distributed paging frames. Therefore, a majority portion or a total time spent in the sleep state may be frontloaded before the clustered set of paging frames, or backloaded after the clustered set of paging frames during the DRX cycle, increasing a contiguous time spent in the sleep state in each DRX cycle of a set of DRX cycles according to the second paging configuration.

As shown by reference number 625, the network node 110 may transmit, and the UE 120 may receive a paging message. For example, the network node 110 may transmit, and the UE 120 may receive, a paging message during a paging occasion of a paging frame of the second paging configuration, based on the monitoring.

As indicated above, FIG. 6 is provided as an example. Other examples may differ from what is described with respect to FIG. 6.

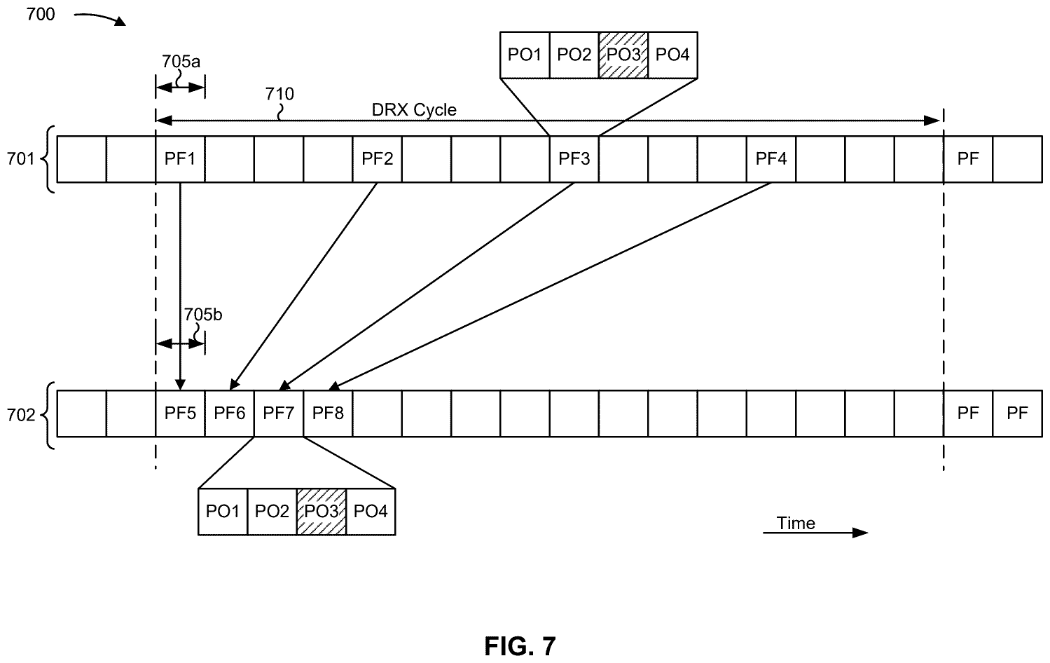

FIG. 7 is a diagram illustrating an example 700 of indicating and/or configuring a clustered paging configuration, in accordance with the present disclosure.

The example 700 depicts resources for communicating messages by a UE (e.g., a UE 120, as described herein) and/or a network node (e.g., network node 110, as described herein) in the context of a wireless communications system (e.g., wireless communications system 100, as described herein).

The example 700 includes a first paging configuration 701 that may be used to determine (e.g., calculate and/or derive) a second paging configuration 702, as described herein and may include a DRX cycle 710.

The UE may determine the PFs and the POs for the first paging configuration 701 using various parameters and equations. For example, the UE 120 may calculate the SFN for each PF to identify which frames to monitor for the paging message by using an equation of the following form:

$$SFN for paging frame ( PF ) : ( SFN + P {F}_{offset} ) mod ( T ) = \frac{T}{N} ( UEID mod ( N ) ) \qquad [ 1 ]$$

where: SFN is the system frame number; PFoffset is a quantity of frames by which a PF is offset (e.g., offset used for PF determination); T is the duration of the DRX cycle; N is the quantity of paging frames per DRX cycle; and UEID is a unique identifier of the UE (e.g., UE ID). In some examples, the UE ID may be a permanent identifier, such as a SUCI, a permanent identifier such as subscriber permanent identifier (SUPI), a 5G-GUTI, or any other unique identifier of the UE. Further, the UE 120 may calculate the PO index to identify which subslots (e.g., PDCCH monitoring occasions) of the PF to monitor for the paging message by using equation of the following form:

$$PO index : {N}_{s} = floor ( \frac{UEID}{N} ) mod ( {N}_{s} ) \qquad [ 2 ]$$

where iₛ is the paging occasion index; and Ns is the quantity of paging occasions per paging frame.

For example, the UE may receive a set of parameters (e.g., one or more of SFN, PFoffset, T, N, UEID, iₛ, or Nₛ) for the first paging configuration 701 and May identify a set of PFs (e.g., PF1, PF2, PF3, and PF4) for the first paging configuration 701 that are evenly distributed throughout the DRX cycle 710 and in which a first occurring PF occurs in a radio frame 705a. For example, PFs of the first paging configuration 701 may be separated from a next occurring paging frame by three paging frames (e.g., 705a, 705a+4, 705a+8, 705a+12).

To determine (e.g., derive, identify) a radio frame (e.g., SFN) for a first occurring (e.g., in time) PF of a set of PFs for the second paging configuration 702, the UE may identify or be configured to determine that the first paging frame of the second paging configuration 702 has the same time resources as the first paging frame of the first paging configuration 701 plus a paging frame network energy saving offset (e.g., PF_NES_offset). For example, the UE may determine that PF5 occurs during radio frame 705b. The remaining PFs of the second paging configuration 702 may be separated by x, paging frames from the first occurring PF of the DRX cycle 710. In some examples, x may be indicated via configuration information along with the parameters for determining the first paging configuration 701, as described herein and with particular reference to FIG. 6. In the example 700, x=0 and the PFs of the second paging configuration 702 occur contiguously, meaning there are no interspersed radio frames between PFs.

In some aspects, the PO indices for the second paging configuration 702 may be calculated in a same manner or may be the same as the first paging configuration 701, described above. That is, Ns may be the same for the first paging configuration 701 and the second paging configuration 702. Additionally, example 700 shows that each of the first paging configuration 701 and the second paging configuration 702 may receive a paging message in PO3 of PF7.

In some other aspects, the UE may receive parameters specific to the second paging configuration 702 via configuration information along with the parameters for determining the first paging configuration 701. For example, the UE may receive N′, Ns′, and PFoffset′ specifically for determining (e.g., calculating) the second paging configuration 702. To determine the paging frames for the second paging configuration 702, the UE may use N′, Ns′, and PFoffset′ to calculate the PFs using the equations described with reference to the first paging configuration 701 of example 700. In some examples, the UE may assume that parameters such as T, UEID, PFoffset, and is for the first paging configuration 701 and the second paging configuration 702 are the same unless otherwise indicated. For example, the UE may use N′, Ns′, and PFoffset′ (e.g., in addition to other parameters such as one or more of T, UEID, PFoffset, or is) in equations [1] and [2] to determine that PF5 is in radio frame 705b for the second paging configuration 702, in addition to using N, Ns and PFoffset (e.g., in addition to other parameters such as one or more of T, UEID, PFoffset, or is) in equation [1] and equation [2] to determine that PF1 is in radio frame 705a for the first paging configuration 701.

As indicated above, FIG. 7 is provided as an example. Other examples may differ from what is described with respect to FIG. 7.

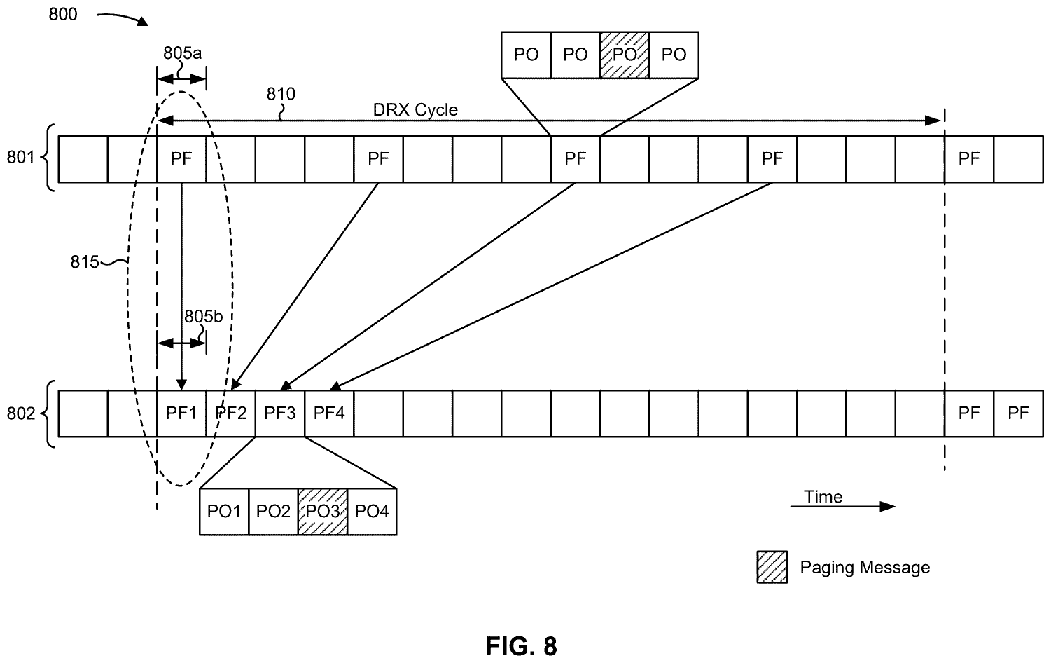

FIG. 8 is a diagram illustrating an example 800 of indicating and/or configuring a clustered paging configuration, in accordance with the present disclosure. The example 800 includes resources for communicating messages by a UE (e.g., a UE 120, as described herein) and/or a network node (e.g., network node 110, as described herein) in the context of a wireless communications system (e.g., wireless communications system 100, as described herein).

The example 800 includes a first paging configuration 801 that may be used to determine (e.g., calculate and/or derive) a second paging configuration 802, as described herein, and may include a DRX cycle 810.

In the example 800, the UE may identify that the frames of the first paging configuration 801 are multiplexed with the paging frames of the second paging configuration 802. In some aspects, there may be a frequency offset between the paging frames of the first configuration and the paging frames of the second configuration. An indication of the frequency offset may be received with the set of parameters (e.g., configuration information, SIB, MIB, or SIB1). In some other aspects, the frequency offset may be fixed (e.g., defined, specified) in a wireless communication specification (e.g., such as the 3GPP specification). In some other aspects, the frequency offset may be equal to a paging occasion frequency bandwidth associated with the first paging configuration 801, where the paging occasion frequency bandwidth associated with the first paging configuration 801 may be signaled with the set of parameters or may be fixed (e.g., defined, specified) in a wireless communication specification (e.g., such as the 3GPP specification). In some aspects, the UE may receive an indication of the frequency offset between the paging frames of the first configuration and the paging frames of the second configuration. For example, based on receiving the indication of the frequency offset, the UE may apply a frequency offset to the paging frames of the second paging configuration 802 such that the paging frames of the first paging configuration 801 and the paging frames of the second paging configuration 802 may at least partially share common time domain resources (e.g., radio frame 805a and radio frame 805b) (e.g., as shown by reference number 815) but do not overlap in the frequency domain.

Additionally, or alternatively, one or more of the set of paging frames of the first paging configuration 801 and one or more paging frames of the second paging configuration 802 may be time division multiplexed with one another. In some aspects, a paging frame of the set of paging frames of the first paging configuration 801 may at least partially overlap with a paging frame of the set of paging frames of the second paging configuration 802 in the frequency domain. In such examples, the UE may perform one or more actions to increase reliability.

In some aspects, the UE may receive a configuration indication or may otherwise receive an indication of one or more collision rules for the first paging configuration 801 and the second paging configuration 802. For example, if paging frames overlap in time, one or more of the following options may be implemented. In some aspects, if a paging frame of the first paging configuration 801 overlaps with a paging frame of the second paging configuration 802, as shown by reference number 815, the paging frame of the second configuration may be dropped (e.g., the UE refrains from monitoring or receiving during the overlapping paging frame of the second configuration) or may be considered an error case. However, in such cases, if the overlapping paging frame of the first configuration is paging a same UE in a same PO, the overlap will have no impact on the reception of the paging message (e.g., the overlapping paging frame of the second configuration will be monitored or received (e.g., not dropped)).

In the example 800, because each of the first paging configuration 801 and the second paging configuration 802 may receive a paging message in PO3 of PF3, the time collision, as shown by reference number 815 may not impact reception of a paging message.

As indicated above, FIG. 8 is provided as an example. Other examples may differ from what is described with respect to FIG. 8.

FIG. 9 is a flowchart of an example method 900 of wireless communication. The method 900 may be performed at, for example, a UE (e.g., UE 120) or an apparatus of a UE.

Method 900 begins at 910 with receiving a set of parameters for a first paging configuration, wherein the set of parameters indicate a DRX cycle, and wherein the set of parameters are associated with a set of paging frames having a first distribution in the DRX cycle. For example, the UE may receive a set of parameters for a first paging configuration, wherein the set of parameters indicate a DRX cycle, and wherein the set of parameters are associated with a set of paging frames having a first distribution in the DRX cycle, as described above in connection with, for example, FIG. 6 and at 610.

Method 900 then proceeds at 920 with monitoring for a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution. For example, the UE may monitor for a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution, as described above in connection with, for example, FIG. 6 and at 620.

In some aspects, the first paging configuration is derived from an identifier of the UE.

In some aspects, the set of parameters further indicates a quantity of paging frames in the DRX cycle and a quantity of paging occasions per paging frame of the first paging configuration.

In some aspects, the quantity of paging occasions per paging frame of the first paging configuration is a same quantity as a quantity of paging occasions per paging frame of the second paging configuration.

In some aspects, paging frames of the clustered set of paging frames occur at an integer interval of x paging frames.

In some aspects, x is indicated in the set of parameters.

In some aspects, x having a value of zero indicates that the clustered set of paging frames are contiguous in time.

In some aspects, paging frames of the set of paging frames occur at a second interval of paging frames that is different from x.

In some aspects, an initial paging frame of the clustered set of paging frames in the DRX cycle occupies a same set of time resources as an initial paging frame of the set of paging frames.

In some aspects, method 900 includes receiving a second set of parameters with the set of parameters for the first paging configuration, and calculating, according to the first paging configuration, a set of paging frame numbers associated with the clustered set of paging frames using the second set of parameters.

In some aspects, the set of parameters is received in a system information block, and method 900 includes deriving the second paging configuration without receiving an updated system information block that indicates the second paging configuration.

In some aspects, a first sleep state duration associated with the first paging configuration is shorter than a second sleep state duration associated with the second paging configuration.

In some aspects, the first distribution is uniform within the DRX cycle and the second distribution is non-uniform within the DRX cycle.

In some aspects, the clustered set of paging frames occupies a set of time resources that is a proper subset of time resources of the DRX cycle.

In some aspects, the first distribution comprises a spacing of the set of paging frames, in time, that is derived from a duration of the DRX cycle, and the second distribution comprises a spacing of the clustered set of paging frames, in time, that is derived from a length of a time interval within the DRX cycle.

In some aspects, the set of paging frames and the clustered set of paging frames are frequency division multiplexed with one another.

In some aspects, a frequency offset between the set of paging frames and the clustered set of paging frames is fixed in a wireless communication specification.

In some aspects, method 900 includes receiving an indication of a frequency offset between the set of paging frames and the clustered set of paging frames.

In some aspects, the indication of the frequency offset is received with the set of parameters.

In some aspects, the set of paging frames and the clustered set of paging frames are time division multiplexed with one another.

In some aspects, an overlapped paging frame of the set of paging frames overlaps with an overlapped clustered paging frame of the clustered set of paging frames.

In some aspects, method 900 includes dropping the overlapped clustered paging frame of the clustered set of paging frames.

In some aspects, monitoring for the paging message comprises monitoring for the paging message during the overlapped clustered paging frame on a frequency resource having a frequency offset with respect to frequency resources of the overlapped paging frame of the set of paging frames.

In some aspects, an indication of the frequency offset is included in the set of parameters, the frequency offset is fixed, or the frequency offset is equal to a paging occasion frequency bandwidth associated with the first paging configuration.

In some aspects, an overlap between a paging frame of the set of paging frames and the paging frame of the clustered set of paging frames is associated with an error case.

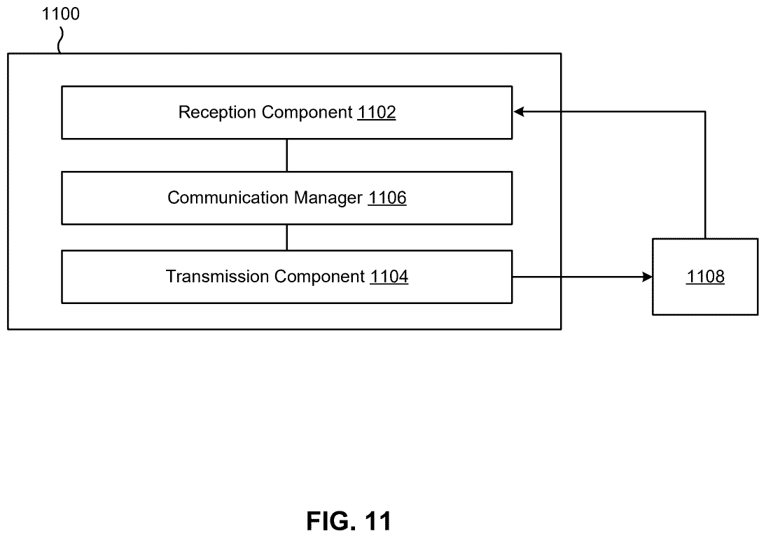

In one aspect, method 900, or any aspect related to it, may be performed by an apparatus, such as communications device 1100 of FIG. 11, which includes various components operable, configured, or adapted to perform the method 900. Communications device 1100 is described below in further detail.

Although FIG. 9 shows example blocks of method 900, in some aspects, method 900 may include additional blocks, fewer blocks, different blocks, or differently arranged blocks than those depicted in FIG. 9. Additionally, or alternatively, two or more of the blocks of method 900 may be performed in parallel.

FIG. 10 is a flowchart of an example method 1000 of wireless communication. The method 1000 may be performed at, for example, a network node (e.g., network node 110) or an apparatus of a network node.

Method 1000 begins at 1010 with transmitting, to a UE, a set of parameters for a first paging configuration, wherein the set of parameters indicate a DRX cycle, and wherein the set of parameters are associated with a set of paging frames having a first distribution in the DRX cycle. For example, the network node may transmit, to a UE, a set of parameters for a first paging configuration, wherein the set of parameters indicate a DRX cycle, and wherein the set of parameters are associated with a set of paging frames having a first distribution in the DRX cycle, as described above in connection with, for example, FIG. 6 and at 610.

Method 1000 then proceeds at 1020 with transmitting a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution. For example, the network node may transmit a paging message during a paging frame of a clustered set of paging frames according to a second paging configuration, wherein the second paging configuration is derived from the first paging configuration, and wherein the clustered set of paging frames have a second distribution, in the cycle, different from the first distribution, as described above in connection with, for example, FIG. 6 and at 625.

In some aspects, the first paging configuration is derived from an identifier of the UE.

In some aspects, the set of parameters further indicates a quantity of paging frames in the DRX cycle and a quantity of paging occasions per paging frame of the first paging configuration.

In some aspects, the quantity of paging occasions per paging frame of the first paging configuration is a same quantity as a quantity of paging occasions per paging frame of the second paging configuration.

In some aspects, paging frames of the clustered set of paging frames occur at an integer interval of x paging frames.

In some aspects, x is indicated in the set of parameters.

In some aspects, x having a value of zero indicates that the clustered set of paging frames are contiguous in time.

In some aspects, paging frames of the set of paging frames occur at a second interval of paging frames that is different from x.

In some aspects, an initial paging frame of the clustered set of paging frames in the DRX cycle occupies a same set of time resources as an initial paging frame of the set of paging frames.

In some aspects, method 1000 includes transmitting a second set of parameters with the set of parameters for the first paging configuration, wherein a set of paging frame numbers associated with the clustered set of paging frames are associated with the second set of parameters.

In some aspects, the set of parameters is transmitted in a system information block, and the second paging configuration is derived without transmitting an updated system information block that indicates the second paging configuration.

In some aspects, a first sleep state duration associated with the first paging configuration is shorter than a second sleep state duration associated with the second paging configuration.

In some aspects, the first distribution is uniform within the DRX cycle and the second distribution is non-uniform within the DRX cycle.

In some aspects, the clustered set of paging frames occupies a set of time resources that is a proper subset of time resources of the DRX cycle.

In some aspects, the first distribution comprises a spacing of the set of paging frames, in time, that is derived from a duration of the DRX cycle, and the second distribution comprises a spacing of the clustered set of paging frames, in time, that is derived from a length of a time interval within the DRX cycle.

In some aspects, the set of paging frames and the clustered set of paging frames are frequency division multiplexed with one another.

In some aspects, a frequency offset between the set of paging frames and the clustered set of paging frames is fixed in a wireless communication specification.

In some aspects, method 1000 includes transmitting an indication of a frequency offset between the set of paging frames and the clustered set of paging frames.

In some aspects, the indication of the frequency offset is transmitted with the set of parameters.

In some aspects, the set of paging frames and the clustered set of paging frames are time division multiplexed with one another.

In some aspects, an overlapped paging frame of the set of paging frames overlaps with an overlapped clustered paging frame of the clustered set of paging frames.

In some aspects, transmitting the paging message comprises transmitting the paging message during the overlapped clustered paging frame on a frequency resource having a frequency offset with respect to frequency resources of the overlapped paging frame of the set of paging frames.

In some aspects, an indication of the frequency offset is included in the set of parameters, the frequency offset is fixed, or the frequency offset is equal to a paging occasion frequency bandwidth associated with the first paging configuration.

In some aspects, an overlap between a paging frame of the set of paging frames and the paging frame of the clustered set of paging frames is associated with an error case.

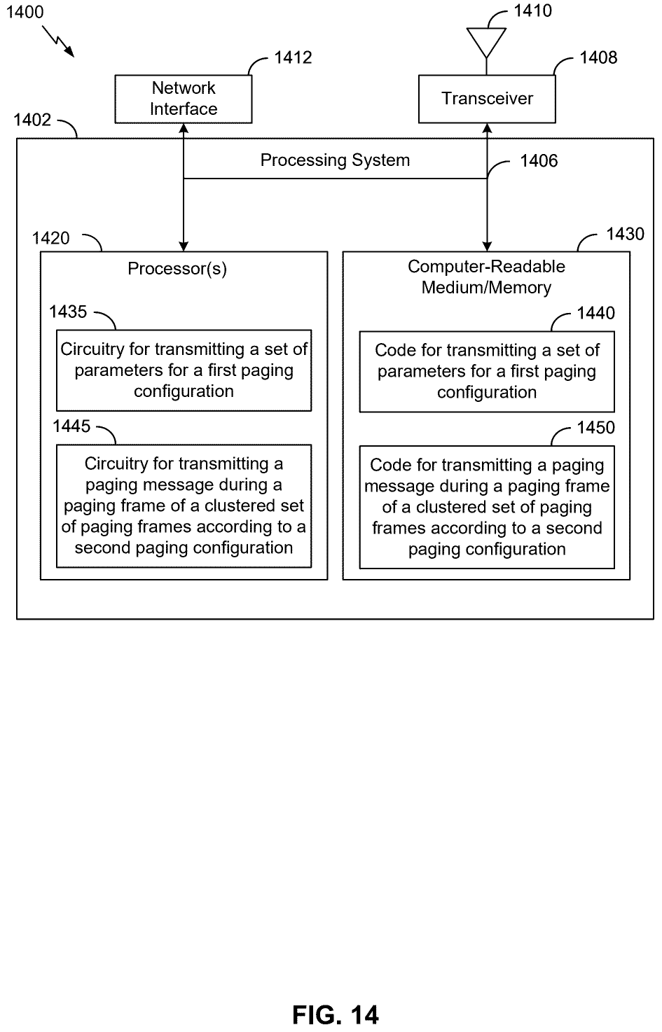

In one aspect, method 1000, or any aspect related to it, may be performed by an apparatus, such as communications device 1400 of FIG. 14, which includes various components operable, configured, or adapted to perform the method 1000. Communications device 1400 is described below in further detail.

Although FIG. 10 shows example blocks of method 1000, in some aspects, method 1000 may include additional blocks, fewer blocks, different blocks, or differently arranged blocks than those depicted in FIG. 10. Additionally, or alternatively, two or more of the blocks of method 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 6-8. Additionally, or alternatively, the apparatus 1100 may be configured to perform one or more processes described herein, such as method 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a set of parameters for a first paging configuration, wherein the set of parameters indicate a DRX cycle, and wherein the set of parameters are associated with a set of paging frames having a first distribution in the DRX cycle. The communication manager 1106 may monitor for a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution.

The reception component 1102 may receive a second set of parameters with the set of parameters for the first paging configuration.

The communication manager 1106 may calculate, according to the first paging configuration, a set of paging frame numbers associated with the clustered set of paging frames using the second set of parameters.

The reception component 1102 may receive an indication of a frequency offset between the set of paging frames and the clustered set of paging frames.

The communication manager 1106 may drop the overlapped clustered paging frame of the clustered set of paging frames.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

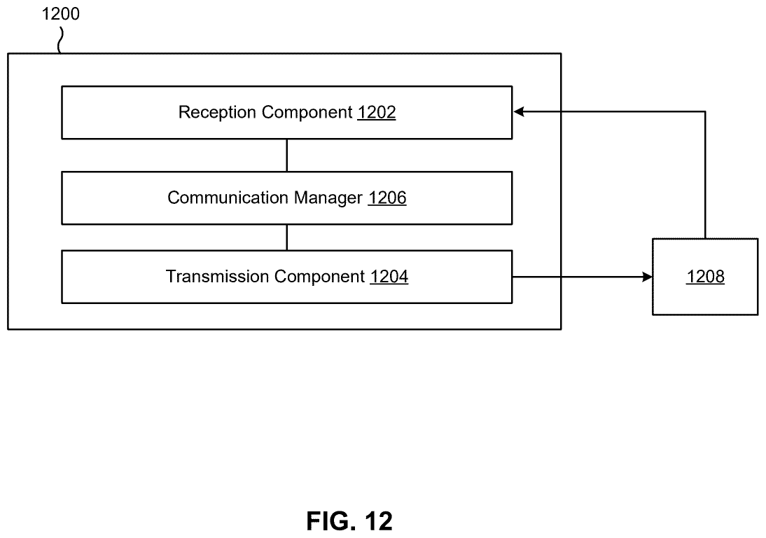

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 6-8. Additionally, or alternatively, the apparatus 1200 may be configured to perform one or more processes described herein, such as method 1000 of FIG. 10, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, to a UE, a set of parameters for a first paging configuration, wherein the set of parameters indicate a DRX cycle, and wherein the set of parameters are associated with a set of paging frames having a first distribution in the DRX cycle. The transmission component 1204 may transmit a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution.

The transmission component 1204 may transmit a second set of parameters with the set of parameters for the first paging configuration, wherein a set of paging frame numbers associated with the clustered set of paging frames are associated with the second set of parameters.

The transmission component 1204 may transmit an indication of a frequency offset between the set of paging frames and the clustered set of paging frames.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

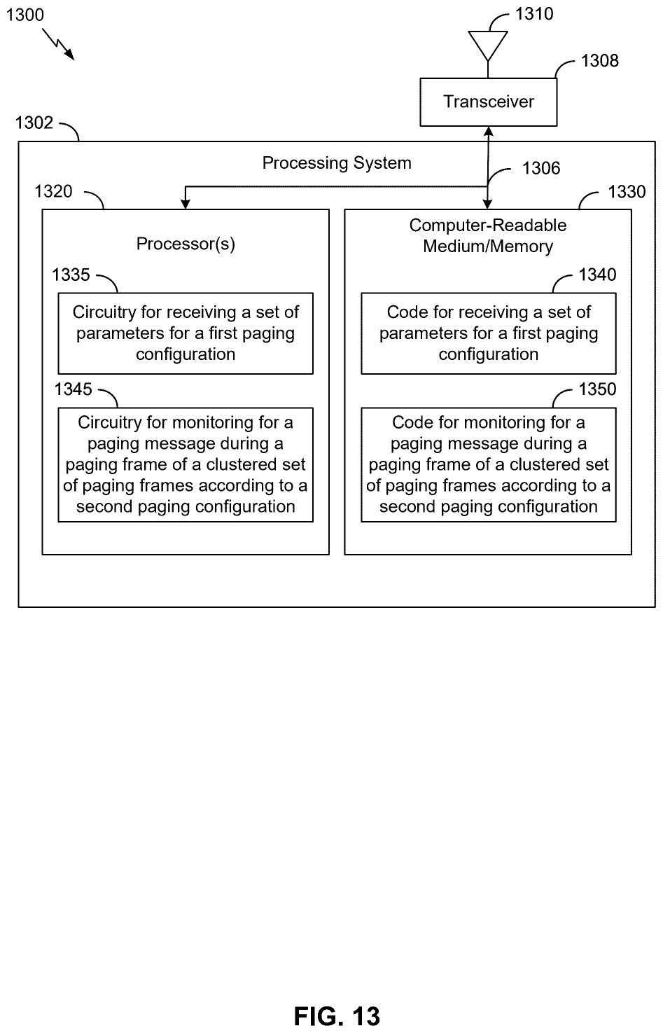

FIG. 13 is a diagram illustrating an example of an implementation of code and circuitry for a communications device 1300, in accordance with the present disclosure. The communications device 1300 may be a UE, or a UE may include the communications device 1300.

The communications device 1300 includes a processing system 1302 coupled to a transceiver 1308 (e.g., a transmitter and/or a receiver, and which may include a single transceivers or multiple transceivers which may perform different operations described as being performed by the transceiver 1308). The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes one or more processors 1320. In various aspects, the one or more processors 1320 may include one or more of receive processor 258, transmit processor 264, TX MIMO processor 266, and/or controller/processor 280, as described with respect to FIG. 2. The one or more processors 1320 are coupled to a computer-readable medium/memory 1330 via a bus 1306. In various aspects, the computer-readable medium/memory 1330 may include one or more memories such as memory 282, as described with respect to FIG. 2. In certain aspects, the computer-readable medium/memory 1330 is configured to store instructions (e.g., computer-executable code, processor-executable code) that when executed by the one or more processors 1320, cause the one or more processors 1320 to perform the method 900 described with respect to FIG. 9, or any aspect related to it. Note that reference to a processor performing a function of communications device 1300 may include one or more processors performing that function of communications device 1300. Note also that reference to one or more processors performing multiple functions may include a first processor performing a first function of the multiple functions and a second processor performing a second function of the multiple functions.

As shown in FIG. 13, the communications device 1300 may include circuitry for receiving a set of parameters for a first paging configuration, wherein the set of parameters indicate a DRX cycle, and wherein the set of parameters are associated with a set of paging frames having a first distribution in the DRX cycle (circuitry 1335).

As shown in FIG. 13, the communications device 1300 may include, stored in computer-readable medium/memory 1330, code for receiving a set of parameters for a first paging configuration, wherein the set of parameters indicate a DRX cycle, and wherein the set of parameters are associated with a set of paging frames having a first distribution in the DRX cycle (code 1340).

As shown in FIG. 13, the communications device 1300 may include circuitry for monitoring for a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution (circuitry 1345).

As shown in FIG. 13, the communications device 1300 may include, stored in computer-readable medium/memory 1330, code for monitoring for a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution (code 1350).

Various components of the communications device 1300 may provide means for performing the method 900 described with respect to FIG. 9, or any aspect related to it. For example, means for transmitting, sending, or outputting for transmission may include the transceiver of the UE 120, as described with reference to FIG. 2, and/or antenna(s) 252 of the UE 120 and/or transceiver 1308 and antenna 1310 of the communications device 1300 in FIG. 13. Means for receiving or obtaining may include the transceiver of the UE 120, as described with reference to FIG. 2, and/or antenna(s) 252 of the UE 120 and/or transceiver 1308 and antenna 1310 of the communications device 1300 in FIG. 13.

FIG. 13 is provided as an example. Other examples may differ from what is described in connection with FIG. 13.

FIG. 14 is a diagram illustrating an example of an implementation of code and circuitry for a communications device 1400, in accordance with the present disclosure. The communications device 1400 may be a network entity (such as network node 110 or a disaggregated base station as described with regard to FIG. 3), or a network entity may include the communications device 1400.

The communications device 1400 includes a processing system 1402 coupled to a transceiver 1408 (e.g., a transmitter and/or a receiver, and which may include a single transceivers or multiple transceivers which may perform different operations described as being performed by the transceiver 1408). The transceiver 1408 is configured to transmit and receive signals for the communications device 1400 via an antenna 1410 (e.g., one or more antennas), such as the various signals as described herein. The network interface 1412 is configured to obtain and send signals for the communications device 1400 via communications link(s), such as a backhaul link, midhaul link, and/or fronthaul link as described herein, such as with respect to FIG. 3. The processing system 1402 may be configured to perform processing functions for the communications device 1400, including processing signals received and/or to be transmitted by the communications device 1400.

The processing system 1402 includes one or more processors 1420. In various aspects, the one or more processors 1420 may include one or more of receive processor 238, transmit processor 264, TX MIMO processor 266, and/or controller/processor 240, as described with respect to FIG. 2. The one or more processors 1420 are coupled to a computer-readable medium/memory 1430 via a bus 1406. In various aspects, the computer-readable medium/memory 1430 may include one or more memories such as memory 242, as described with respect to FIG. 2. In certain aspects, the computer-readable medium/memory 1430 is configured to store instructions (e.g., computer-executable code, processor-executable code) that when executed by the one or more processors 1420, cause the one or more processors 1420 to perform the method 1000 described with respect to FIG. 10, or any aspect related to it. Note that reference to a processor performing a function of communications device 1400 may include one or more processors performing that function of communications device 1400. Note also that reference to one or more processors performing multiple functions may include a first processor performing a first function of the multiple functions and a second processor performing a second function of the multiple functions.

As shown in FIG. 14, the communications device 1400 may include circuitry for transmitting, to a UE, a set of parameters for a first paging configuration, wherein the set of parameters indicate a DRX cycle, and wherein the set of parameters are associated with a set of paging frames having a first distribution in the DRX cycle (circuitry 1435).

As shown in FIG. 14, the communications device 1400 may include, stored in computer-readable medium/memory 1430, code for transmitting, to a UE, a set of parameters for a first paging configuration, wherein the set of parameters indicate a DRX cycle, and wherein the set of parameters are associated with a set of paging frames having a first distribution in the DRX cycle (code 1440).

As shown in FIG. 14, the communications device 1400 may include circuitry for transmitting a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution (circuitry 1445).

As shown in FIG. 14, the communications device 1400 may include, stored in computer-readable medium/memory 1430, code for transmitting a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution (code 1450).

Various components of the communications device 1400 may provide means for performing the method 1000 described with respect to FIG. 10, or any aspect related to it. For example, means for transmitting, sending, or outputting for transmission may include the transceiver of the network node 110, as described with reference to FIG. 2 and/or antenna(s) 234 of the network node 110 and/or the transceiver 1408 and/or antenna 1410 of the communications device 1400 in FIG. 14. Means for receiving or obtaining may include the transceiver of the network node, as described with reference to FIG. 2 and/or antenna(s) 234 of the network node 110 and/or the transceiver 1408 and/or antenna 1410 of the communications device 1400 in FIG. 14.

FIG. 14 is provided as an example. Other examples may differ from what is described in connection with FIG. 14.

The following provides an overview of some aspects of the present disclosure:

Aspect 1: A method of wireless communication performed by a user equipment (UE), comprising: receiving a set of parameters for a first paging configuration, wherein the set of parameters indicate a DRX cycle, and wherein the set of parameters are associated with a set of paging frames having a first distribution in the DRX cycle; and monitoring for a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution.

Aspect 2: The method of Aspect 1, wherein the first paging configuration is derived from an identifier of the UE.

Aspect 3: The method of any of Aspects 1-2, wherein the set of parameters further indicates a quantity of paging frames in the DRX cycle and a quantity of paging occasions per paging frame of the first paging configuration.

Aspect 4: The method of Aspect 3, wherein the quantity of paging occasions per paging frame of the first paging configuration is a same quantity as a quantity of paging occasions per paging frame of the second paging configuration.

Aspect 5: The method of any of Aspects 1-4, wherein paging frames of the clustered set of paging frames occur at an integer interval of x paging frames.

Aspect 6: The method of Aspect 5, wherein x is indicated in the set of parameters.

Aspect 7: The method of any of Aspects 5-6, wherein x having a value of zero indicates that the clustered set of paging frames are contiguous in time.

Aspect 8: The method of any of Aspects 5-7, wherein paging frames of the set of paging frames occur at a second interval of paging frames that is different from x.

Aspect 9: The method of any of Aspects 1-8, wherein an initial paging frame of the clustered set of paging frames in the DRX cycle occupies a same set of time resources as an initial paging frame of the set of paging frames.

Aspect 10: The method of any of Aspects 1-9, further comprising: receiving a second set of parameters with the set of parameters for the first paging configuration; and calculating, according to the first paging configuration, a set of paging frame numbers associated with the clustered set of paging frames using the second set of parameters.

Aspect 11: The method of any of Aspects 1-10, wherein the set of parameters is received in a system information block, the method further comprising: deriving the second paging configuration without receiving an updated system information block that indicates the second paging configuration.

Aspect 12: The method of any of Aspects 1-11, wherein a first sleep state duration associated with the first paging configuration is shorter than a second sleep state duration associated with the second paging configuration.

Aspect 13: The method of any of Aspects 1-12, wherein the first distribution is uniform within the DRX cycle and the second distribution is non-uniform within the DRX cycle.

Aspect 14: The method of any of Aspects 1-13, wherein the clustered set of paging frames occupies a set of time resources that is a proper subset of time resources of the DRX cycle.

Aspect 15: The method of any of Aspects 1-14, wherein: the first distribution comprises a spacing of the set of paging frames, in time, that is derived from a duration of the DRX cycle, and the second distribution comprises a spacing of the clustered set of paging frames, in time, that is derived from a length of a time interval within the DRX cycle.

Aspect 16: The method of any of Aspects 1-15, wherein the set of paging frames and the clustered set of paging frames are frequency division multiplexed with one another.

Aspect 17: The method of Aspect 16, wherein a frequency offset between the set of paging frames and the clustered set of paging frames is fixed in a wireless communication specification.

Aspect 18: The method of any of Aspects 16-17, further comprising: receiving an indication of a frequency offset between the set of paging frames and the clustered set of paging frames.

Aspect 19: The method of Aspect 18, wherein the indication of the frequency offset is received with the set of parameters.

Aspect 20: The method of any of Aspects 1-19, wherein the set of paging frames and the clustered set of paging frames are time division multiplexed with one another.

Aspect 21: The method of Aspect 20, wherein an overlapped paging frame of the set of paging frames overlaps with an overlapped clustered paging frame of the clustered set of paging frames.

Aspect 22: The method of Aspect 21, further comprising: dropping the overlapped clustered paging frame of the clustered set of paging frames.

Aspect 23: The method of Aspect 21, wherein monitoring for the paging message comprises: monitoring for the paging message during the overlapped clustered paging frame on a frequency resource having a frequency offset with respect to frequency resources of the overlapped paging frame of the set of paging frames.

Aspect 24: The method of Aspect 23, wherein: an indication of the frequency offset is included in the set of parameters, the frequency offset is fixed, or the frequency offset is equal to a paging occasion frequency bandwidth associated with the first paging configuration.

Aspect 25: The method of any of Aspects 1-24, wherein an overlap between a paging frame of the set of paging frames and the paging frame of the clustered set of paging frames is associated with an error case.

Aspect 26: A method of wireless communication performed by a network node, comprising: transmitting, to a user equipment (UE), a set of parameters for a first paging configuration, wherein the set of parameters indicate a DRX cycle, and wherein the set of parameters are associated with a set of paging frames having a first distribution in the DRX cycle; and transmitting a paging message during a paging frame of a clustered set of paging frames according to a second paging configuration, wherein the second paging configuration is derived from the first paging configuration, and wherein the clustered set of paging frames have a second distribution, in the DRX cycle, different from the first distribution.

Aspect 27: The method of Aspect 26, wherein the first paging configuration is derived from an identifier of the UE.

Aspect 28: The method of any of Aspects 26-27, wherein the set of parameters further indicates a quantity of paging frames in the DRX cycle and a quantity of paging occasions per paging frame of the first paging configuration.

Aspect 29: The method of Aspect 28, wherein the quantity of paging occasions per paging frame of the first paging configuration is a same quantity as a quantity of paging occasions per paging frame of the second paging configuration.

Aspect 30: The method of any of Aspects 26-29, wherein paging frames of the clustered set of paging frames occur at an integer interval of x paging frames.

Aspect 31: The method of Aspect 30, wherein x is indicated in the set of parameters.

Aspect 32: The method of any of Aspects 30-31, wherein x having a value of zero indicates that the clustered set of paging frames are contiguous in time.

Aspect 33: The method of any of Aspects 30-32, wherein paging frames of the set of paging frames occur at a second interval of paging frames that is different from x.

Aspect 34: The method of any of Aspects 26-33, wherein an initial paging frame of the clustered set of paging frames in the DRX cycle occupies a same set of time resources as an initial paging frame of the set of paging frames.

Aspect 35: The method of any of Aspects 26-34, further comprising: transmitting a second set of parameters with the set of parameters for the first paging configuration, wherein a set of paging frame numbers associated with the clustered set of paging frames are associated with the second set of parameters.

Aspect 36: The method of any of Aspects 26-35, wherein: the set of parameters is transmitted in a system information block, and the second paging configuration is derived without transmitting an updated system information block that indicates the second paging configuration.

Aspect 37: The method of any of Aspects 26-36, wherein a first sleep state duration associated with the first paging configuration is shorter than a second sleep state duration associated with the second paging configuration.

Aspect 38: The method of any of Aspects 26-37, wherein the first distribution is uniform within the DRX cycle and the second distribution is non-uniform within the DRX cycle.

Aspect 39: The method of any of Aspects 26-38, wherein the clustered set of paging frames occupies a set of time resources that is a proper subset of time resources of the DRX cycle.

Aspect 40: The method of any of Aspects 26-39, wherein: the first distribution comprises a spacing of the set of paging frames, in time, that is derived from a duration of the DRX cycle, and the second distribution comprises a spacing of the clustered set of paging frames, in time, that is derived from a length of a time interval within the DRX cycle.

Aspect 41: The method of any of Aspects 26-40, wherein the set of paging frames and the clustered set of paging frames are frequency division multiplexed with one another.

Aspect 42: The method of Aspect 41, wherein a frequency offset between the set of paging frames and the clustered set of paging frames is fixed in a wireless communication specification.

Aspect 43: The method of any of Aspects 41-42, further comprising: transmitting an indication of a frequency offset between the set of paging frames and the clustered set of paging frames.

Aspect 44: The method of Aspect 43, wherein the indication of the frequency offset is transmitted with the set of parameters.

Aspect 45: The method of any of Aspects 26-44, wherein the set of paging frames and the clustered set of paging frames are time division multiplexed with one another.

Aspect 46: The method of Aspect 45, wherein an overlapped paging frame of the set of paging frames overlaps with an overlapped clustered paging frame of the clustered set of paging frames.

Aspect 47: The method of Aspect 46, wherein transmitting the paging message comprises: transmitting the paging message during the overlapped clustered paging frame on a frequency resource having a frequency offset with respect to frequency resources of the overlapped paging frame of the set of paging frames.

Aspect 48: The method of Aspect 47, wherein: an indication of the frequency offset is included in the set of parameters, the frequency offset is fixed, or the frequency offset is equal to a paging occasion frequency bandwidth associated with the first paging configuration.

Aspect 49: The method of any of Aspects 26-48, wherein an overlap between a paging frame of the set of paging frames and the paging frame of the clustered set of paging frames is associated with an error case.

Aspect 50: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-49.

Aspect 51: An apparatus for wireless communication at a device, the apparatus comprising one or more memories and one or more processors coupled to the one or more memories, the one or more processors configured to cause the device to perform the method of one or more of Aspects 1-49.

Aspect 52: An apparatus for wireless communication, the apparatus comprising at least one means for performing the method of one or more of Aspects 1-49.

Aspect 53: A non-transitory computer-readable medium storing code for wireless communication, the code comprising instructions executable by one or more processors to perform the method of one or more of Aspects 1-49.

Aspect 54: A non-transitory computer-readable medium storing a set of instructions for wireless communication, the set of instructions comprising one or more instructions that, when executed by one or more processors of a device, cause the device to perform the method of one or more of Aspects 1-49.

Aspect 55: A device for wireless communication, the device comprising a processing system that includes one or more processors and one or more memories coupled with the one or more processors, the processing system configured to cause the device to perform the method of one or more of Aspects 1-49.

Aspect 56: An apparatus for wireless communication at a device, the apparatus comprising one or more memories and one or more processors coupled to the one or more memories, the one or more processors individually or collectively configured to cause the device to perform the method of one or more of Aspects 1-49.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus configured for wireless communication at a user equipment (UE), comprising:
one or more memories comprising processor-executable instructions; and
one or more processors configured to execute the processor-executable instructions and cause the apparatus to:
receive a set of parameters for a first paging configuration, wherein the set of parameters indicate a discontinuous reception cycle, and wherein the set of parameters are associated with a set of paging frames having a first distribution in the discontinuous reception cycle; and
monitor for a paging message during a paging frame of a clustered set of paging frames according to a second paging configuration, wherein the second paging configuration is derived from the first paging configuration, and wherein the clustered set of paging frames have a second distribution, in the discontinuous reception cycle, different from the first distribution.

2. The apparatus of claim 1, wherein the set of parameters indicates a quantity of paging frames in the discontinuous reception cycle and a quantity of paging occasions per paging frame of the first paging configuration.

3. The apparatus of claim 2, wherein the quantity of paging occasions per paging frame of the first paging configuration is a same quantity as a quantity of paging occasions per paging frame of the second paging configuration.

4. The apparatus of claim 1, wherein paging frames of the clustered set of paging frames occur at an integer interval of x paging frames.

5. The apparatus of claim 1, wherein an initial paging frame of the clustered set of paging frames in the discontinuous reception cycle occupies a same set of time resources as an initial paging frame of the set of paging frames.

6. The apparatus of claim 1, wherein the one or more processors are configured to cause the apparatus to:
receive a second set of parameters with the set of parameters for the first paging configuration; and
calculate, according to the first paging configuration, a set of paging frame numbers associated with the clustered set of paging frames using the second set of parameters.

7. The apparatus of claim 1, wherein the set of parameters is received in a system information block, and wherein the one or more processors are configured to cause the apparatus to:
derive the second paging configuration without receiving an updated system information block that indicates the second paging configuration.

8. The apparatus of claim 1, wherein the first distribution is uniform within the discontinuous reception cycle and the second distribution is non-uniform within the discontinuous reception cycle.

9. The apparatus of claim 1, wherein the clustered set of paging frames occupies a set of time resources that is a proper subset of time resources of the discontinuous reception cycle.

10. The apparatus of claim 1, wherein:
the first distribution comprises a spacing of the set of paging frames, in time, that is derived from a duration of the discontinuous reception cycle, and
the second distribution comprises a spacing of the clustered set of paging frames, in time, that is derived from a length of a time interval within the discontinuous reception cycle.

11. The apparatus of claim 1, wherein the set of paging frames and the clustered set of paging frames are frequency division multiplexed with one another.

12. The apparatus of claim 11, wherein a frequency offset between the set of paging frames and the clustered set of paging frames is fixed in a wireless communication specification.

13. The apparatus of claim 11, wherein the one or more processors are configured to cause the apparatus to:
receive an indication of a frequency offset between the set of paging frames and the clustered set of paging frames.

14. The apparatus of claim 1, wherein the set of paging frames and the clustered set of paging frames are time division multiplexed with one another.

15. The apparatus of claim 14, wherein an overlapped paging frame of the set of paging frames overlaps with an overlapped clustered paging frame of the clustered set of paging frames.

16. The apparatus of claim 15, wherein the one or more processors are configured to cause the apparatus to:
drop the overlapped clustered paging frame of the clustered set of paging frames.

17. The apparatus of claim 15, wherein the one or more processors, to cause the apparatus to monitor for the paging message, are configured to cause the apparatus to:
monitor for the paging message during the overlapped clustered paging frame on a frequency resource having a frequency offset with respect to frequency resources of the overlapped paging frame of the set of paging frames.

18. The apparatus of claim 17, wherein:
an indication of the frequency offset is included in the set of parameters,
the frequency offset is fixed, or
the frequency offset is equal to a paging occasion frequency bandwidth associated with the first paging configuration.

19. A method of wireless communication performed by a user equipment (UE), comprising:
receiving a set of parameters for a first paging configuration, wherein the set of parameters indicate a discontinuous reception cycle, and wherein the set of parameters are associated with a set of paging frames having a first distribution in the discontinuous reception cycle; and
monitoring for a paging message during a paging frame of a clustered set of paging frames according to a second paging configuration, wherein the second paging configuration is derived from the first paging configuration, and wherein the clustered set of paging frames have a second distribution, in the discontinuous reception cycle, different from the first distribution.

20. A non-transitory computer-readable medium storing a set of instructions, the set of instructions comprising:
one or more instructions that, when executed by one or more processors of a user equipment (UE), cause the UE to:
receive a set of parameters for a first paging configuration, wherein the set of parameters indicate a discontinuous reception cycle, and wherein the set of parameters are associated with a set of paging frames having a first distribution in the discontinuous reception cycle; and
monitor for a paging message during a paging frame of a clustered set of paging frames according to a second paging configuration, wherein the second paging configuration is derived from the first paging configuration, and wherein the clustered set of paging frames have a second distribution, in the discontinuous reception cycle, different from the first distribution.
